(19) United States
(12) Patent Application Publication
(10) Pub. No.: US 2024/0396787 A1
(43) Pub. Date: Nov. 28, 2024

(54) Optimization of GNB Failure Detection and Fast Activation of Fallback Mechanism

(71) Applicant: Nokia Technologies Oy, Espoo (FI)

(72) Inventors: Ece GOSHI, Munich (DE); Omer BULAKCI, Munich (DE); Subramanya CHANDRASHEKAR, Bangalore (IN)

(21) Appl. No.: 18/686,724

(22) PCT Filed: Aug. 23, 2022
(86) PCT No.: PCT/EP2022/073423

§ 371 Date: Feb. 26, 2024

(30) Foreign Application Priority Data
Aug. 27, 2021 (IN) 202111038917

(51) Int. Cl. H04L 41/0604; H04L 41/069

(52) U.S. Cl. CPC H04L 41/0604; H04L 41/069

(57) ABSTRACT

A method includes transmitting an indication to create a notification publish space to a data storage function, the notification publish space including an identifier of a central entity of an access network node being monitored for failure; receiving an acknowledgement of the indication to create the notification publish space from the data storage function; and transmitting the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node.

### TECHNICAL FIELD

The examples and non-limiting embodiments relate generally to communications and, more particularly, to optimization of gNB failure detection and fast activation of fallback mechanism.

### BACKGROUND

It is known to implement a backup system in a communication network to prevent service disruption.

### SUMMARY

In accordance with an aspect, a method includes receiving an indication to create a notification publish space to monitor failure, from a central entity of an access network node, the notification publish space comprising an identifier of the central entity of the access network node being monitored for failure; creating the notification publish space, and sending an acknowledgement of the indication to create the notification publish space to the central entity of the access network node; receiving a subscription to the notification publish space from at least one logical entity of the access network node or of another access network node; receiving a failure notification of a failure of the at least one logical entity being monitored for failure; and notifying the subscribers of the notification publish space concerning the failure of the at least one logical entity.

In accordance with an aspect, a method includes transmitting an indication to create a notification publish space to a data storage function, the notification publish space comprising an identifier of a central entity of an access network node being monitored for failure; receiving an acknowledgement of the indication to create the notification publish space from the data storage function; and transmitting the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node.

In accordance with an aspect, a method includes receiving a identifier from a central entity of an access network node, the identifier used to identify a notification publish space of a radio access network data storage function; subscribing to the notification publish space of the radio access network data storage function using the identifier of the central entity being monitored for failure, the notification publish space used to provide or receive information concerning a failure of at least one logical entity of the access network node or of another access network node being monitored for failure; and receiving a notification of failure of the at least one logical entity with the notification publish space of the radio access network data storage function, the notification of failure comprising an identifier of the failed at least one logical entity.

In accordance with an aspect, a method includes detecting a failure of at least one logical entity of an access network node being monitored for failure; and transmitting a notification to a radio access network data storage function of the failure of the at least one logical entity, the notification comprising an identifier of the failed at least one logical entity; wherein the notification is configured to be used with the radio access network data storage function to notify subscribers of a notification publish space concerning the failure of the at least one logical entity; wherein the notification publish space is accessible to the subscribers of the notification publish space to be notified of the failure.

In accordance with an aspect, a method includes creating an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

In accordance with an aspect, a method includes establishing an interface with at least one logical entity; and detecting a failure of the at least one logical entity and transmitting a failure notification of the at least one logical entity, or receiving a notification of failure of the at least one logical entity; wherein the notification of failure is received using an associated node list, the associated node list having been created and updated based on interface establishment between a plurality of logical entities of the at least one logical entity and/or a node configuration update procedure; wherein the at least one logical entity and the plurality of logical entities are entities of at least one access network node.

In accordance with an aspect, a method includes receiving an associated node list from a central unit control plane entity, the associated node list having been created based on interface establishment between a plurality of logical entities of at least one logical entity and/or a node configuration update procedure; storing the associated node list, wherein the associated node list configured to be used for a notification of failure of the at least one logical entity; detecting the failure of the at least one logical entity; and performing either: transmitting a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmitting the notification of failure to a set of the at least one logical entity using the associated node list; wherein the associated node list is stored with a near real time radio intelligent controller; wherein the at least one logical entity, the plurality of logical entities, the central unit control plane entity, and the standby central unit control plane entity are entities of at least one access network node.

In accordance with an aspect, a method includes synchronizing an associated node list between a central unit control plane entity and a standby central unit control plane entity, the associated node list configured to be used for transmission of a notification of failure; storing the associated node list; wherein the associated node list is created based on interface establishment between a plurality of logical entities of at least one logical entity; receiving a failure notification from a near real time radio intelligent controller or the at least one logical entity; and transmitting the notification of failure to the at least one logical entity using the associated node list; wherein the at least one logical entity, the plurality of logical entities, the central unit control plane entity, and the standby central unit control plane entity are entities of at least one access network node.

### BRIEF DESCRIPTION OF THE DRAWINGS

The foregoing aspects and other features are explained in the following description, taken in connection with the accompanying drawings.

FIGS. 1A and 1B are block diagrams of possible and non-limiting exemplary systems in which the exemplary embodiments may be practiced.

FIGS. 1C-1, 1C-2, and 1D are block diagrams of exemplary configurations of the non-real time (non-RT) and near real-time (near-RT) radio intelligent controllers (RICs) from FIG. 1A and

FIG. 1B.

FIG. 2 is a diagram illustrating SBA in 5GC and SBMA in 5G network management.

FIG. 3 is a block diagram of an example O-RAN architecture.

FIG. 4 is a block diagram depicting a resiliency and robustness operation framework in SB-RAN.

FIG. 5 is a block diagram depicting a resiliency and robustness operation framework in the current PAN based on P2P interfaces.

FIG. 6 is a signaling diagram showing an example resiliency and robustness in SB-RAN message sequence chart.

FIG. 7 is a signaling diagram showing an example resiliency and robustness in NR PAN message sequence chart.

FIG. 8 is an example implementation of a radio node suitable for an O-RAN environment.

FIG. 9 is a block diagram depicting nodes within an SB-PAN architecture.

FIG. 10 is a block diagram depicting nodes within an NR PAN architecture.

FIG. 11 is an apparatus configured to implement the examples described herein.

FIG. 12 is an example method implementing the examples described herein.

FIG. 13 is an example method implementing the examples described herein.

FIG. 14 is an example method implementing the examples described herein.

FIG. 15 is an example method implementing the examples described herein.

FIG. 16 is an example method implementing the examples described herein.

FIG. 17 is an example method implementing the examples described herein.

FIG. 18 is an example method implementing the examples described herein.

FIG. 19 is an example method implementing the examples described herein.

FIG. 20 is an example method implementing the examples described herein.

FIG. 21 is an example method implementing the examples described herein.

### DETAILED DESCRIPTION OF EXAMPLE EMBODIMENTS

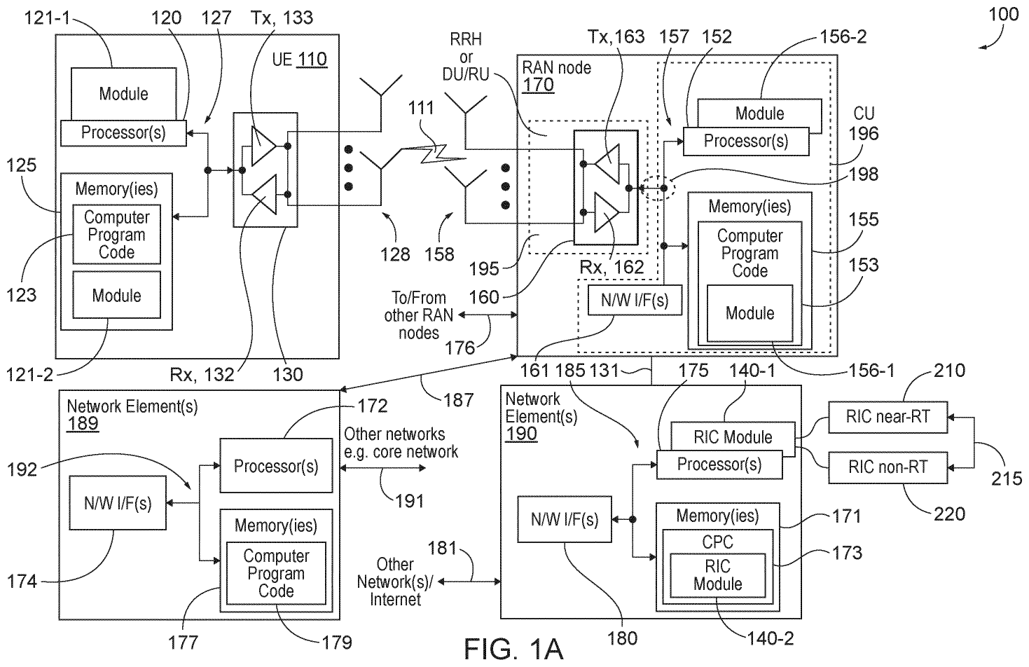

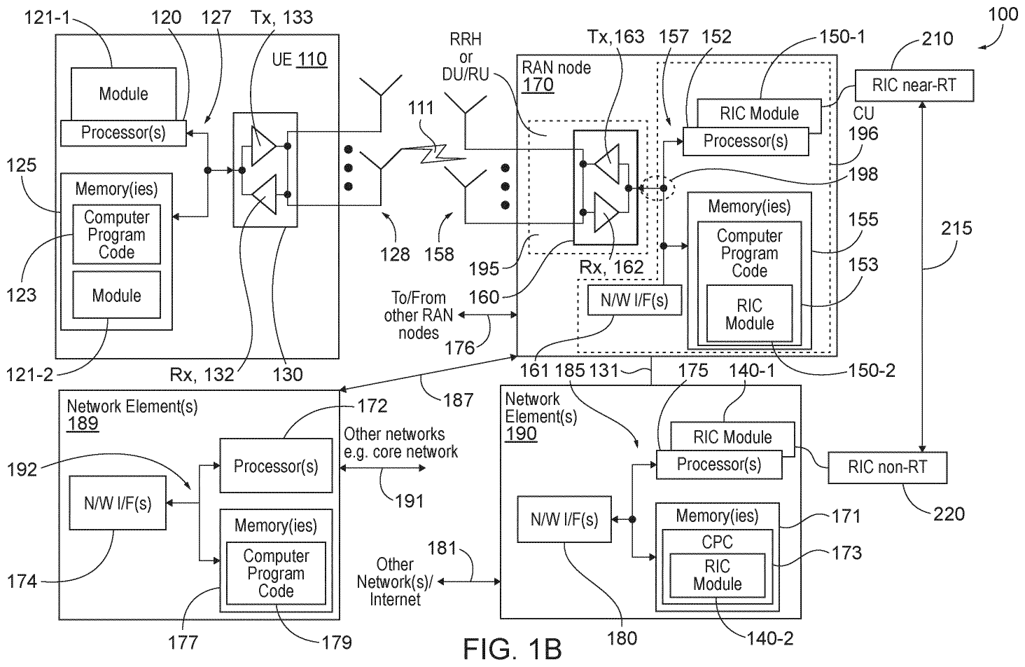

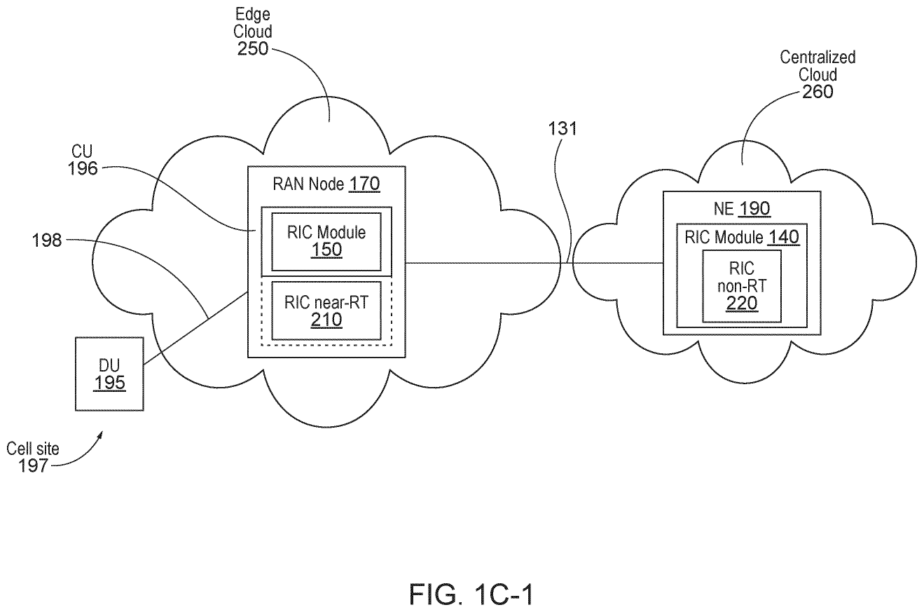

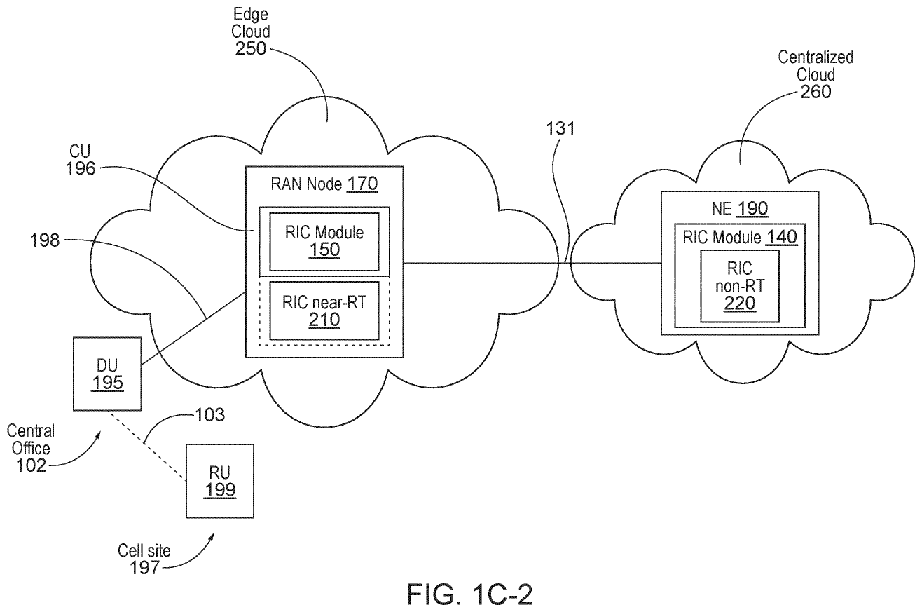

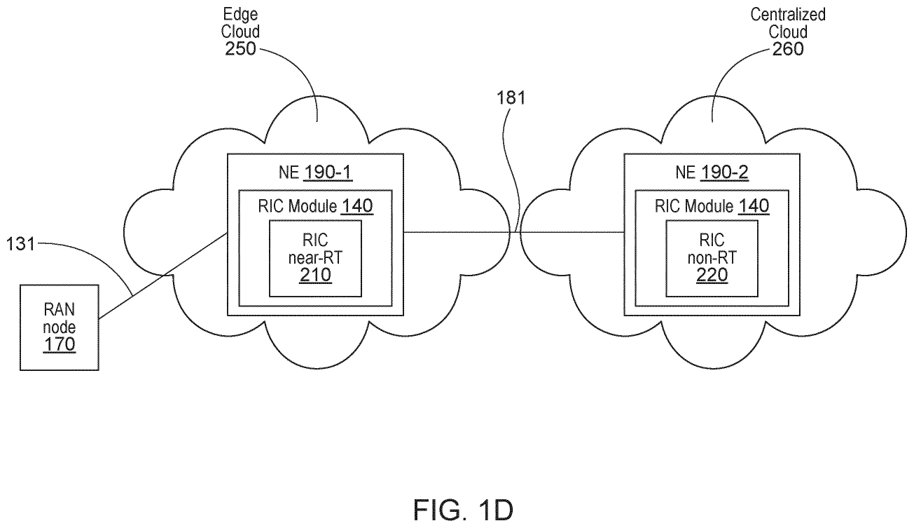

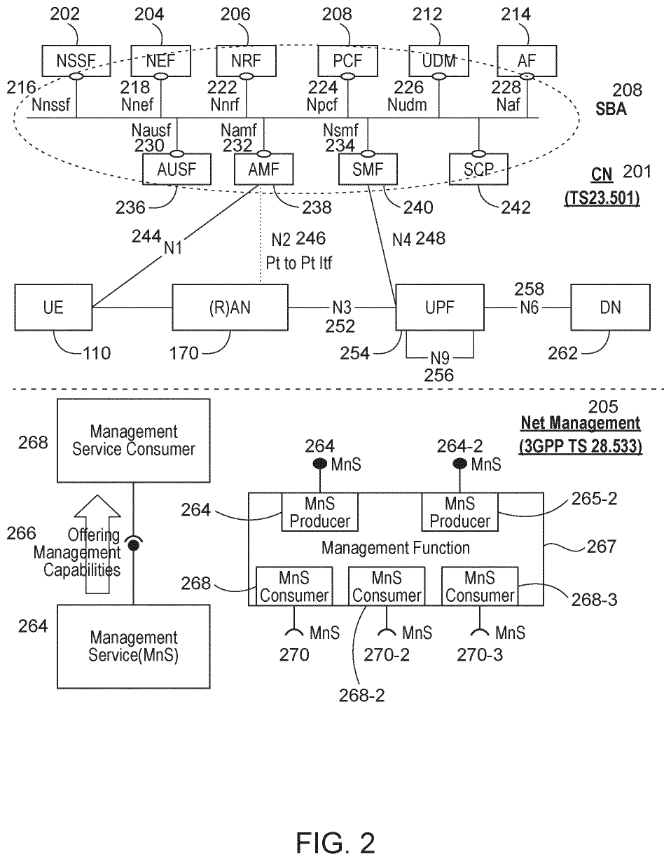

Turning to FIG. 1A, this figure shows a block diagram of one possible and non-limiting exemplary system in which the exemplary embodiments may be practiced. In FIG. 1A, a user equipment (UE) 110, a radio access network (RAN) node 170, and one or more network element(s) (NE(s)) 190 are illustrated. FIG. 1A illustrates possible configurations of RICs known as a near-real time (near-RT) RIC 210 and a non-RT RIC 220. These configurations are described in more detail after the elements in FIG. 1A are introduced and also in reference to FIGS. 1B, 1C-1, 1C-2, and 1D.

In FIG. 1A, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 121, comprising one of or both parts 121-1 and/or 121-2, which may be implemented in a number of ways. The module 121 may be implemented in hardware as module 121-1, such as being implemented as part of the one or more processors 120. The module 121-1 may be implemented also as an integrated circuit or through other hardware such as a programmable gate array. In another example, the module 121 may be implemented as module 121-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111. The modules 121-1 and 121-2 may be configured to implement the functionality of the UE as described herein.

The PAN node 170 in this example is a base station that provides access by wireless devices such as the UE 110 to the wireless network 100. The PAN node 170 may be, for instance, a base station for 5G, also called New Radio (NR). The RAN node 170 may be, for instance, a base station for beyond 5G, e.g., 6G. In 5G, the PAN node 170 may be a NG-RAN node, which is defined as either a gNB or an ng-eNB. The gNB 170 is a node providing NR user plane and control plane protocol terminations towards the UE, and connected via an O1 interface 131 to the network element(s) 190. The ng-eNB is a node providing E-UTRA user plane and control plane protocol terminations towards the UE, and connected via the NG interface 131 to the 5GC. The NG-PAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting RRC, SDAP and PDCP protocols of the gNB or RRC and PDCP protocols of the en-gNB that control the operation of one or more gNB-DUs 195. The gNB-CU 196 terminates the F1 interface connected with the gNB-DU 195. The F1 interface is illustrated as reference 198, although reference 198 also illustrates connection between remote elements of the RAN node 170 and centralized elements of the PAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell is typically supported by only one gNB-DU 195. The gNB-DU 195 terminates the F1 interface 198 connected with the gNB-CU 196. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The PAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memory(ies) 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 156, also referred to as radio intelligent controller herein, module 156, comprising one of or both parts 156-1 and/or 1560-2, which may be implemented in a number of ways. The module 156 may be implemented in hardware as 156-1, such as being implemented as part of the one or more processors 152. The module 156-1 may be implemented also as an integrated circuit or through other hardware such as a programmable gate array. In another example, the 156 may be implemented as module 156-2, which is implemented as computer program code 153 and is executed by the one or more processors 152. For instance, the one or more memories 155 and the computer program code 153 are configured to, with the one or more processors 152, cause the PAN node 170 to perform one or more of the operations as described herein. Note that the functionality of the module 156 may be distributed, such as being distributed between the DU 195 and the CU 196, or be implemented solely in the DU 195. In some embodiments, the module 156 can be a RIC module, e.g., near-RT RIC.

The one or more network interfaces 161 communicate over a network such as via the links 176 and 131. Two or more gNBs 170 communicate using, e.g., link 176. The link 176 may be wired or wireless or both and may implement, e.g., an Xn interface for 5G, an X2 interface for LTE, or other suitable interface for other standards, e.g., interfaces that may be specified for beyond 5G system, for example, 6G.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, e.g., fiber optic cable or other suitable network connection to connect the other elements (e.g., a central unit (CU), gNB-CU 196) of the RAN node 170 to the RRH/DU 195. Reference 198 also indicates those suitable network connection(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element (NE) (or elements, NE(s)) 190 that may implement SMO/OAM functionality, and that is connected via a link or links 181 with a further network, such as a telephone network and/or a data communications network (e.g., the Internet). The PAN node 170 is coupled via a link 131 to the network element 190. The link 131 may be implemented as, e.g., an O1 interface for SMO/OAM, or other suitable interface for other standards. The network element 190 includes one or more processors 175, one or more memories 171, and one or more network interfaces (N/W I/F(s)) 180, interconnected through one or more buses 185. The one or more memories 171 include computer program code (CPC) 173. The one or more memories 171 and the computer program code 173 are configured to, with the one or more processors 175, cause the network element 190 to perform one or more operations. The network element 190 includes a RIC module 140, comprising one of or both parts 140-1 and/or 140-2, which may be implemented in a number of ways. The RIC module 140 may be implemented in hardware as RIC module 140-1, such as being implemented as part of the one or more processors 175. The RIC module 140-1 may be implemented also as an integrated circuit or through other hardware such as a programmable gate array. In another example, the RIC module 140 may be implemented as RIC module 140-2, which is implemented as computer program code 173 and is executed by the one or more processors 175. In some examples, a single RIC could serve a large region covered by hundreds of base stations. The network element(s) 190 may be one or more network control elements (NCEs).

The wireless network 100 may include a network element or elements 189 that may include core network functionality, and which provides connectivity via a link or links 191 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 189, and note that both 5G and LTE functions might be supported. The PAN node 170 is coupled via a link 187 to the network element 189. The link 187 may be implemented as, e.g., an NG interface for 5G, or an S1 interface for LTE, or other suitable interface for other standards. The network element 189 includes one or more processors 172, one or more memories 177, and one or more network interfaces (N/W I/F(s)) 174, interconnected through one or more buses 192. The one or more memories 177 include computer program code 179.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 or 172 and memories 155 and 171 and 177, and also such virtualized entities create technical effects.

The computer readable memories 125, 155, 171, and 177 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, 171, and 177 may be means for performing storage functions. The processors 120, 152, 175, and 172 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, 175, and 172 may be means for performing functions, such as controlling the UE 110, PAN node 170, network element(s) 190, network element(s) 189, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. The UE 100 may also be a head mounted display that supports virtual reality, augmented reality, or mixed reality.

FIG. 1B is configured similar to FIG. 1A, except for the location of the near-RT RIC 210.

### Possible Configurations of Radio Intelligent Controllers (RICs)

Possible configurations are shown of RICs known as a near-real time (near-RT) RIC 210 and a non-RT RIC 220 in FIGS. 1A, 1B, 1C-1, 1C-2, and 1D. There are a number of possibilities for the locations of the near-RT RIC 210 and the non-RT RIC 220.

One possible instantiation of RIC non-RT 220 and RIC near-RT 210 is these are entities separate from the PAN node 170. This is illustrated by FIG. 1A, where both the RIC near-RT 210 and the RIC non-RT 220 could be implemented by a single network element 190 or by multiple network elements 190. As shown in FIG. 1A and FIG. 1B, the RIC near-RT 210 and the RIC non-RT 220 are connected via interface 215, which may be an A1 interface.

However it is also possible that the RIC near-RT 210 functionality may be a part of the PAN node 170, in a couple of cases:
1) The PAN node itself may be composed of a centralized unit (CU) that may reside in the edge cloud, and so the RAN CU 196 and the RIC near-RT 210 would be at least collocated, and maybe even combined; or
2) The RIC near-RT 210 functionality may be possibly hosted inside a RAN node 170.

FIG. 1B illustrates that the RIC near-RT 210 may be implemented in the RAN node 170, e.g., combined with a RIC module 150 (e.g., as part of RIC module 150-1 as shown or RIC module 150-2 or some combination of those). In this example, the RIC non-RT 220 would be implemented in the network element 190, e.g., as part of the RIC module 140 (e.g., as part of RIC module 140-1 as shown or RIC module 140-2 or some combination of those).

FIG. 1C-1 illustrates a RAN node 170 in an edge cloud 250. The RAN node 170 includes a CU 196 that includes the RIC module 150 and, as a separate entity, the RIC near-RT 210. The separate RIC near-RT 210 could be implemented by the processor(s) 152 and memory(ies) 155 (and/or other circuitry) by the RAN node 170 or have its own, separate processor(s) and memories (and/or other circuitry). This is the collocation from (1) above. The combined aspect of (1) above is illustrated by the dashed line around the RIC near-RT 210, indicating the RIC near-RT 210 is also part of the CU 196. FIG. 1C-1 also illustrates the RIC non-RT 220 may be implemented as part of the RIC module 140 in a network element 190 that is in a centralized cloud 260. In the example of FIG. 1C-1, the DU 195 are typically located at the cell site 197 and may include the RU.

The edge cloud 250 may be viewed as a “hosting location”, e.g., a kind of data center. Multiple elements may be hosted there, such as the CU, RIC, and yet other functions like MEC (mobile edge computing) platforms, and the like.

In the example of FIG. 1C-2, the DU 195 could also be located in a central office 102, in so-called Centralized-RAN configurations. In these configurations, the DU 195 is at the central office 102, but the RU 199 is at the cell site 197, and the DU 195 is interconnected to the RU 199 typically by a fiber network 103 or other suitable network (the so-called “Fronthaul”).

It is also possible the RIC near-RT 210 may be located at an edge cloud, at some relatively small latency from the RAN node (such as 30-100 ms), while the RIC non-RT 220 may be at a greater latency likely in a centralized cloud. This is illustrated by FIG. 1D, where network element 190-1 is located at an edge cloud 250 and comprises the RIC module 140 which incorporates the RIC near-RT 210. The RIC non-RT 220, meanwhile, is implemented in this example in the RIC module 140 of another NCE 190-2 in the centralized cloud 260.

Accordingly, UE 110, PAN node 170, network element(s) 190, network element(s) 189 (and associated memories, computer program code and modules), edge cloud 250, centralized cloud 260, and/or the RIC near-RT module 210 may be configured to implement the methods described herein, including optimization of gNB failure detection and fast activation of fallback mechanism.

Having thus introduced suitable but non-limiting technical contexts for the practice of the exemplary embodiments described herein, the exemplary embodiments are now described with greater specificity.

The examples described herein include both 3GPP and O-PAN aspects. 3GPP aspects are related to a beyond 5G/6G service-based PAN architecture.

Resiliency in PAN is an important aspect in providing service continuity and avoiding downtime. Specifically, gNB-CU-CP (Central Unit-Control Plane) resiliency can be vital for UE service continuity after failure. Various examples and embodiments described herein can utilize gNB-CU resiliency based on an inactive SCTP connection to standby CU-CPs.

Each gNB logical entity currently may detect a failure on its own based on timer expiries, which can be long to avoid false detection. An important aspect in this regard is optimization of failure detection times by using a collaborative approach among connected gNB logical entities to initiate fallback mechanisms faster. Regarding this, the examples described herein provide a solution that can be applied in the current PAN architecture with point-to-point (P2P) interfaces as well as in the SB-RAN (service based-RAN) architecture. The examples described herein also consider implications in the O-RAN environment.

The examples described herein can relate to the 3GPP, O-RAN, and other related standardizations.

### SB-RAN

Mobile and wireless communications networks are increasingly deployed in cloud environments. Furthermore, 5G and new generations beyond 5G are aimed to be flexible by adding new functionalities into the system capitalizing on the cloud implementations. To this end, as shown in FIG. 2, the 5G core network (5GC) 201 is defined as a service-based (SB) architecture (SBA) 203 [3GPP TS 23.501], and the network management 205 is also employing SBA principles, referred to as the service-based management architecture (SBMA) [3GPP TS 28.533].

In the 5GC SBA, a consumer inquires a network repository function (NRF) in order to discover an appropriate service producer entity. That is, in 5GC in order to discover and select the appropriate service entities, multiple filtering criteria may be applied by the NRF.

5GC SBA Application Programming Interfaces (APIs) are based on the HTTP(S) protocol. A Network Function (NF) service is one type of capability exposed by an NF (NF service producer entity) to another authorized NF (NF service consumer entity) through a service-based interface (SBI). A Network Function (NF) may expose one or more NF services. NF services may communicate directly between NF service consumer entities and NF service producer entities, or indirectly via a Service Communication Proxy (SCP).

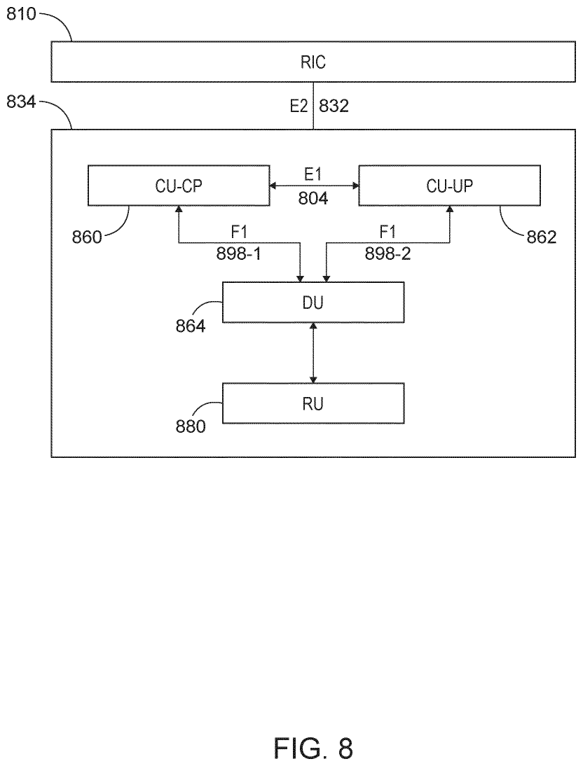

However, the Access Network (AN), e.g., Radio AN (RAN) 170, and the associated interfaces, e.g., within the AN, among ANs and between the AN and Core Network (CN) 201 are defined as legacy P2P interfaces since the very early generations of PLMN. For example, in the 5G System (5GS), N2 246 is designed as a 3GPP NG-C Application Protocol over SCTP, between the gNB 170 (or ng-eNB) and the AMF 238 (Access and Mobility management Function). Further P2P interface examples within the AN are the Xn interface (e.g. item 176 of FIG. 1) between two gNBs, the F1 interface (e.g. items 898-1 and 898-2 of FIG. 8, and item 198 of FIG. 1) between a central unit (CU) and a distributed unit (DU) in case of a disaggregated gNB and the E1 interface (refer e.g. to item 804 of FIG. 8) between the CU-CP and the CU-UP in case of a disaggregated CU [3GPP TS 38.401].

An access network (AN) can be defined as a network that offers access (such as radio access) to one or more core networks, and that is enabled to connect subscribers to the one or more core networks. The access network may provide 3GPP access such as GSM/EDGE, UTRA, E-UTRA, or NR access or non-3GPP access such as WLAN/Wi-Fi. The access network is contrasted with the core network, which is an architectural term relating to the part of the network (e.g. 3GPP network) which is independent of the connection technology of the terminal (e.g. radio, wired) and which provides core network services such as subscriber authentication, user registration, connectivity to packet data networks, subscription management, etc. An access network and a core network may correspond respectively e.g. to a 3GPP access network and 3GPP core network.

Herein, an entity can be, e.g., a logical entity, an access node, a base station, a part of an access node or base station, a protocol stack, a part of a protocol stack, a network function, a part of a network function, or the like.

Application of SBA principles to the (R)AN may imply substantial updates to the mobile and wireless communication networks and, thus, various aspects may be considered to be realized in the next generations beyond 5G.

As further shown in FIG. 2, the SBA 203 is comprised of an NSSF 202 coupled to the bus 207 via Nnssf 216, an NEF 204 coupled to the bus 207 via Nnef 218, an NRF 206 coupled to the bus 207 via Nnrf 222, a PCF 208 coupled to the bus 207 via the Npcf 224, a UDM 212 coupled to the bus 207 via the Nudm 226, and an AF 214 coupled to the bus 207 via the Naf 228. The SBA 203 is further comprised of an AUSF 236 coupled to the bus 207 via Nausf 230, an AMF 238 coupled to the bus 20 via Namf 232, a SMF 240 coupled to the bus 207 via Nsmf 234, and an SCP 242 coupled to the bus 207. The coupling enables each network function to provide and/or consume services via defined APIs through the mentioned reference points, such as Nnssf 216, Nnef 218, Nnrf 222, Npcf 224, Nudm 226, Naf 228, Nausf 230, Namf 232, and Nsmf 234.

The N1 interface 244 connects the UE 110 to the AMF 238, the N3 interface 252 connects the RAN node 170 to the UPF 254, which UPF 254 is coupled to the SMF 240 via the N4 248 interface. UPF 254 is coupled to the DN 262 via the N6 interface 258. Further the N9 interface 256 connects items within UPF 254 to each other, or the N9 interface 256 is an interface between different UPFs.

As further shown in FIG. 2, the network management 205 comprises a management service (MnS) 264 which offers management capabilities 266 to a management service consumer 268. In particular, the network management provides a management function 267, such that instantiations of the management service (264 and 264-2) invoke instantiations of an MnS producer (respectively 265 and 265-2). Different instantiations of the MnS consumer (268, 268-2, 268-2) utilize the management function 267 to generate output (respectively 270, 270-2, 270-3).

It is to be noted that, in the present disclosure, a service-based configuration, architecture or framework can encompass a microservice configuration, architecture or framework. That is, a service-based (R)AN according to at least one exemplifying embodiment may be based on or comprise a microservice approach such that one or more network functions or one or more services within one or more network functions or one or more functionalities/mechanisms/processes of services of one or more network functions represent or comprise a set/collection of interacting microservices. Accordingly, in a service-based (R)AN according to at least one exemplifying embodiment, a service may be produced or provided by any one of a network function, a microservice, a communication control entity or a cell.

Microservices can be understood as more modular services (as compared with services produced/provided by NFs) that come together to provide a meaningful service/application. In this scope, one can deploy and scale the small modules flexibly (e.g. within a NF or between various NFs). For example, a NF provides a service, and a microservice can represent small modules that make up the service. When a service is clogged at a specific module, then one can scale the individual module/s in microservice scope instead of the whole service as it would happen in network function scope. In microservice scope, energy saving according to at least one exemplifying embodiment would work the other way around, namely there is no need for a specific module to operate the service anymore, so the individual microservice would be shut down or deactivated.

### O-RAN & Near-RT RIC

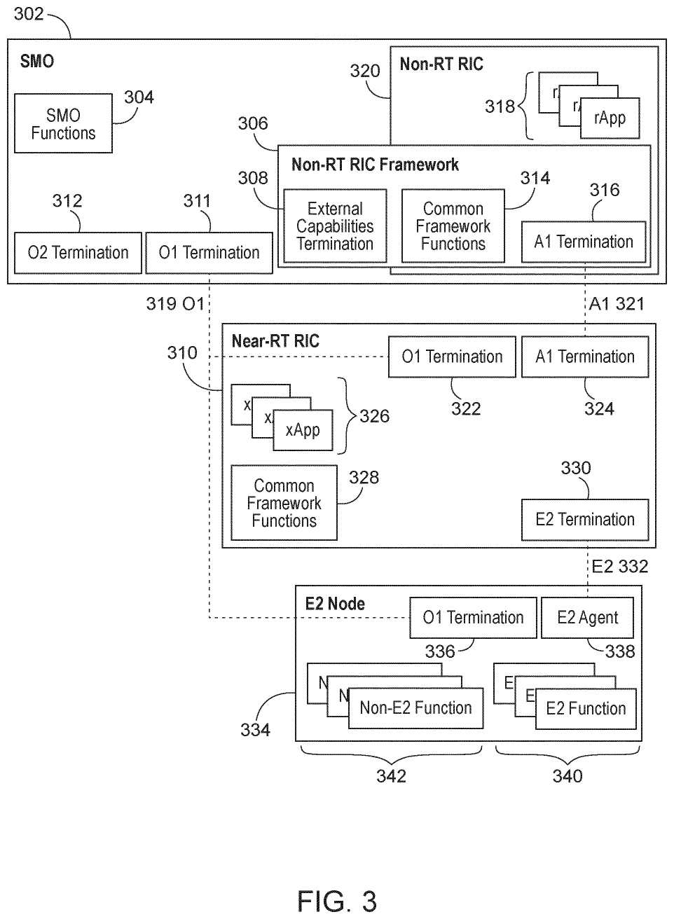

Near-RT RIC 310 (refer to FIG. 3) hosts xApps 326 to provide value-added services (regarding time-sensitive management and control of radio resources) through the E2 interface 332 to E2 Nodes (O-CU-CP, O-CU-UP (Central Unit User Plane), O-DU (Distributed Unit), and O-eNB), including E2 node 334. Near-RT RIC services consist of REPORT, CONTROL, INSERT, and POLICY and are realized through E2 Application Protocol (E2AP) procedures.

In the event of E2 332 or Near-RT RIC failure 310, the E2 Node 334 is able to provide services but with the caveat that there can be an outage for value-added services that may only be provided using the Near-RT RIC 310 (e.g. via the xApps 326). Failures of the RIC, such as item 310, are detected based on service response timer expiries, data transmission over connection timer expiries, etc. The data transmission over connection timer expiries refer to transport layer-related timer expiries, whereas service response timer expiries relate to application-/procedure-related timer expiries.

As further shown in FIG. 3, the SMO 302 comprises the non-RT RIC 320, where the non-RT RIC 320 hosts rApps 318. The SMO 302 further provides SMO functions 304 and a non-RT RIC framework 306 which provides an external capabilities termination 308, common framework functions 314, and an A1 termination 316. The SMO further comprises an O1 termination 311 and an O2 termination 312. As shown in FIG. 3, the O1 termination 311 of the SMO 302 is coupled to the O1 termination 322 of the near-RT RIC 310, and to the O1 termination 336 of the E2 node 334, via the O1 interface 319. The A1 termination 316 of the SMO 302 is coupled to the A1 termination 324 of the near-RT RIC 310 via the A1 interface 321.

As further shown in FIG. 3, the near-RT RIC 310 comprises common framework functions 328 and an E2 termination 330 coupled to the E2 agent 338 of the E2 node 334 via the E2 interface 332. The E2 node 334 provides/hosts E2 functions 340 and non-E2 functions 342.

Each gNB logical entity/E2 node may detect a failure on its own based on timer expiries. Generally, the failure detection involves long timers to avoid false detection.

In O-RAN, in the event of failure, the E2 node 334 may have to wait unnecessarily long to execute a subsequent action, causing service disruptions in the range of milliseconds as well as seconds (e.g. 60 s is also mentioned as a possible value in the O-RAN specifications). For example, there may be a combined service subscription, such as a REPORT service disruption followed by a POLICY service disruption. Accordingly, the E2 node 334 reports the necessary input data (e.g.: PM counters, traces, KPIs, signaling messages etc.) based on which the RIC (e.g. 310) may prepare/change policy. If a Near-RT RIC 310 failure occurs before receiving the POLICY, the aforementioned service disruption can occur. A UE specific INSERT/CONTROL mechanism may not be preferable over the E2 interface 332, where the issue is much more prominent due to the fact that a RIC failure while waiting for response of the INSERT procedure may cause an RLF of the UEs. Even if the E2 interface 332 is limited to a REPORT/POLICY mechanism (which may be preferred), the non-real time nature of the procedures may mean that detection of RIC failure may not happen simultaneously at all E2 nodes. It is also sub-optimal to perform failure detection separately at each E2 node (such as E2 node 334) with long undue wait times.

Such a discrete and individual failure detection is also a problem in case of a gNB-CU-CP failure (refer to item 860 of FIG. 8) where each connected client (DU, CU-UP, AMF, RIC, gNB, eNB etc.) detects failure on its own.

Such failure detection framework also implies the following: there is currently no mechanism to notify the associated gNB logical entity/E2 node 334 of an already detected failure. Therefore the failure detection times are not optimized and fallback mechanisms cannot be kicked in faster. Associated entities are defined as entities among which a direct C-plane or U-plane interface is established.

Various examples and embodiments described herein address the resiliency and robustness of a gNB (e.g. PAN node 170) by optimizing the failure detection times and fast fallback mechanism activation. They propose a respective solution applicable in a PAN, SB-RAN and O-RAN environment by making use of the relations among gNBs and/or gNB entities. By doing so, the examples described herein address a technical gap toward the realization of PAN resiliency.

Various examples and embodiments described herein provide a solution to optimize the duration of service disruptions and activation of fallback mechanisms in a gNB and/or logical entities of an NG-RAN node in the following cases, 1-2 (also considering the O-RAN environment implications): 1. Notification of failure of NG-RAN logical entities (e.g., gNB-CU-CP, DU, CU-UP) (or E2 Node in O-RAN) to all associated NG-RAN entities (or E2 Node and Near-RT RIC in O-RAN) for activation of fallback/recovery actions; and 2. Notification of Near-RT RIC failure to the associated E2 nodes in an O-RAN environment to activate the default fallback mechanism without having to perform failure detection on their own.

Associated NG-RAN node entities can be defined as those with which a direct C-plane or U-plane interface is established.

The below embodiments are described to realize the herein described solution: create and store a list of NG-RAN logical entities, based on their unique IDs, that are associated to each other via F1/E1/Xn/NG/X2 interfaces. Create and store a list of E2 Nodes, based on their unique IDs, that are associated to a Near-RT RIC via an E2 interface. Upon failure detection of a Near-RT RIC by an E2 Node or failure detection of NG-RAN node logical entity by another NG-RAN node logical entity/Near-RT RIC, the node that detects the failure uses the list to notify the entities or a subset of the entities in the created list so that the respective entities can initiate their fallback mechanisms earlier than detecting the failure themselves, which can take a long time depending on service configurations (in the range of milliseconds, seconds, minutes, etc.).

Two solution alternatives are described herein for creating/storing/updating and broadcasting of failure notification, considering current peer-to-peer (P2P) interfaces and the novel service-based RAN (SB-RAN) architecture (1-2 immediately below with various example and embodiments).

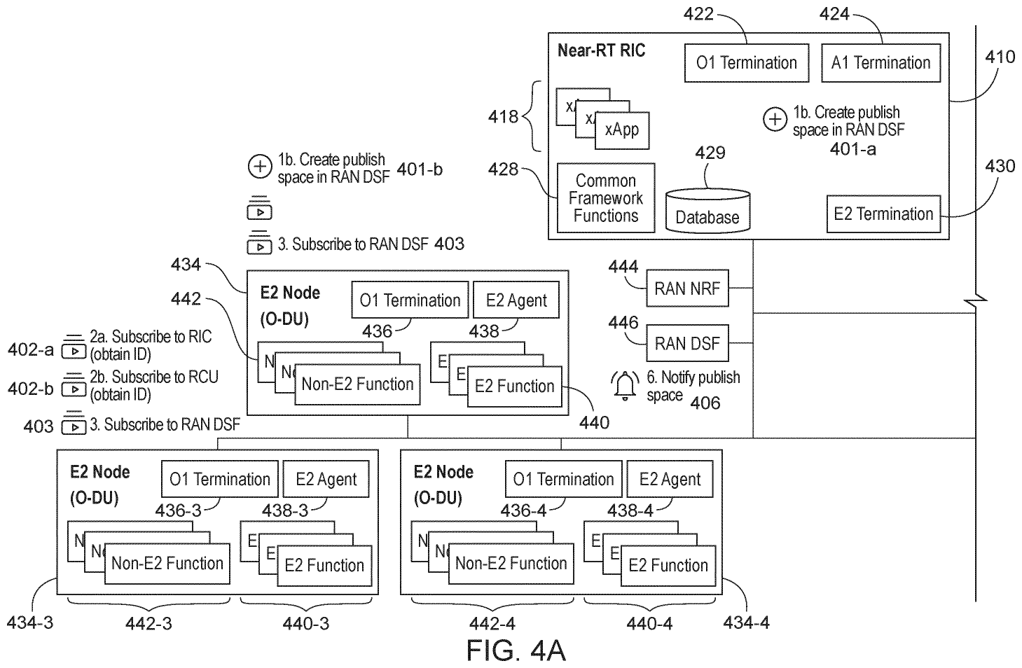

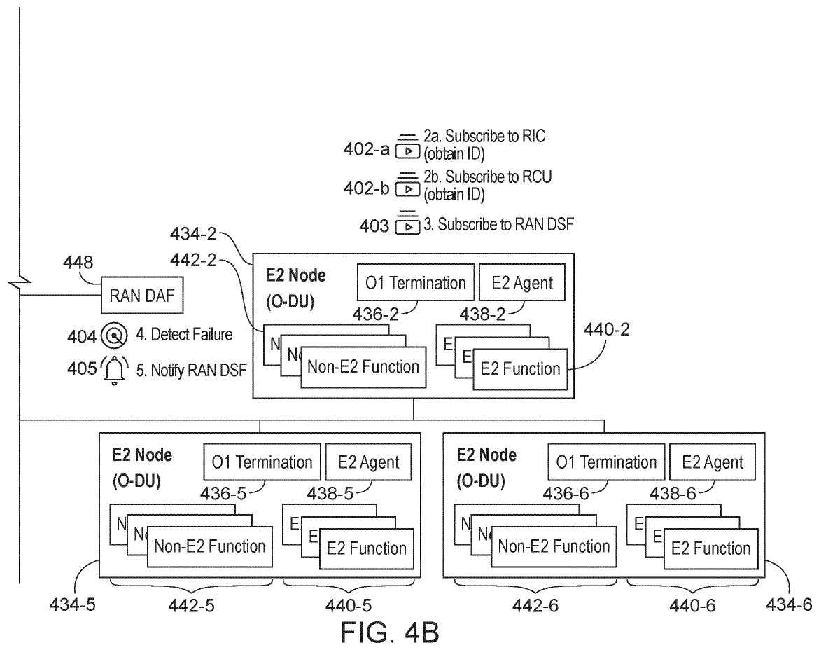

1. Notification based on the SB-RAN architecture and principles (refer to FIG. 4). A central entity creates a publish space based on its unique ID (401-a, 401-b), e.g. in the PAN data storage function (DSF) 446. In the case of NG-RAN Node logical entity/E2 Node failure, the central entity can be the gNB-CU-CP, responsible for creating the publish space (401-b). In the case of near-RT RIC failure, the central entity can be the Near-RT RIC 410, responsible for creating the publish space (401-a). The publish space ID is shared with each NG-RAN logical entity/E2 Node during respective service subscriptions with the central entity (402-a, 402-b). All NG-RAN logical entities/E2 Nodes can subscribe to the RAN-DSF 446 with the provided ID (403). All NG-RAN logical entities/E2 nodes, network functions, and microservices permitted to perform failure detection are also allowed to publish information into the created publish space in the PAN DSF 446. The RAN-DSF 446 maintains a list of associated NG-RAN logical entities/E2 nodes, perhaps including the near-RT RIC 410 and the E2 nodes shown in FIG. 4 (434, 434-2, 434-3, 434-4, 434-5, 434-6). Upon failure detection (404), the node detecting the failure publishes the failure info into the publish space (e.g. via notify PAN DSF 405). The PAN DSF 446 shall notify all the subscribers of that space about the failure event (406). The notification message includes the identifier of the failed entity and any other necessary information regarding the failure.

Although some of the examples described herein depict and describe the PAN-DSF as a single NF, the PAN-DSF may be implemented as part of a data storage architecture that may include one or more elements (e.g., functions or nodes). For example, a PAN data storage architecture may include a RAN-DSF, a data repository, and/or a data management entity. Moreover, different deployment options may be implemented, where the elements may be collocated. Furthermore, the elements of the data storage architecture may perform storage and retrieval of data, such as UE context information.

In some example embodiments, there is provided a data storage function (DSF) having a service-based interface (SBI). In some example embodiments, the DSF is a (R)AN element (function, or node), in which case it is referred to as a (R)AN-DSF. The (R)AN DSF may be used to retrieve (e.g., fetch), store, and update a notification publish space. These operations may be performed by any authorized network function (NF), such as a source gNB base station, a target gNB base station, Near-RT RIC, and/or other network functions or entities in the (R)AN and/or core. The DSF may be accessed by an authorized central entity to create a notification publish space. Moreover, the notification publish space at the DSF may be accessed for updating in case of an event occurrence requiring an update on notification publish space or for retrieving in case of an event occurrence requiring the fetching of notification publish space. The DSF may provide notification publish space storage, update, fetch and any other operation that may provide efficient handling of monitoring and notifying the failure of a network entity in the network.

In some example embodiments, there is provided a data analytics function (DAF) having a service-based interface (SBI). In some example embodiments, the DAF is a (R)AN element (function, or node), in which case it is referred to as a (R)AN-DAF. The (R)AN DAF may be used to collect and analyze data that may be useful for monitoring/detecting/predicting the operational state of the network entities for a failure as well as notify the respective entities about a potential or detected failure. Said data can be collected from a network function that provides storage of such data, such (R)AN-DSF. Monitoring, detecting, and predicting the network entity state can performed via any mechanism which can be based on server timer expiries, transport layer-related timer expiries, AI/ML methods, or any other mechanism that provides the failure detection/prediction functionality. The detected/predicted failure at the (R)AN-DAF can be notified to the respective entity in the network that is responsible for notifying the all the network entities potentially affected by the failure. Such respective entity can be (R)AN-DSF.

As further shown in FIG. 4, included in the SB-RAN architecture is the near-RT RIC 410, O-CU E2 nodes (434, 434-2), and several O-DU E2 nodes (434-3, 434-4, 434-5, 434-6). The near-RT RIC 410 comprises an O1 termination 422, an A1 termination 424, common framework functions 428, a database 429, and an E2 termination 430. The near-RT RIC 410 hosts one or more xApps 418. Each of the E2 nodes comprises an O1 termination (436, 436-2, 436-3, 436-4, 436-5, 436-6), an E2 agent (438, 438-2, 438-3, 438-4, 438-5, 438-6), one or more E2 functions (440, 440-2, 440-3, 440-4, 440-5, 440-6), and one or more non-E2 functions (442, 442-2, 442-3, 442-4, 442-5, 442-6). Also shown in FIG. 4 is the RAN NRF 444 and the RAN DAF 448.

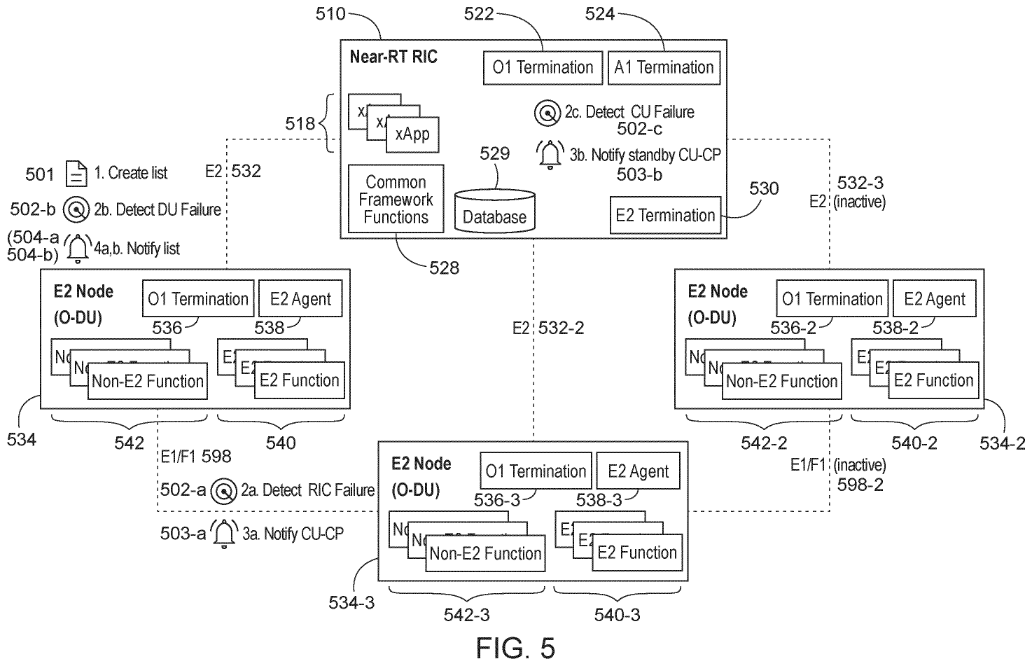

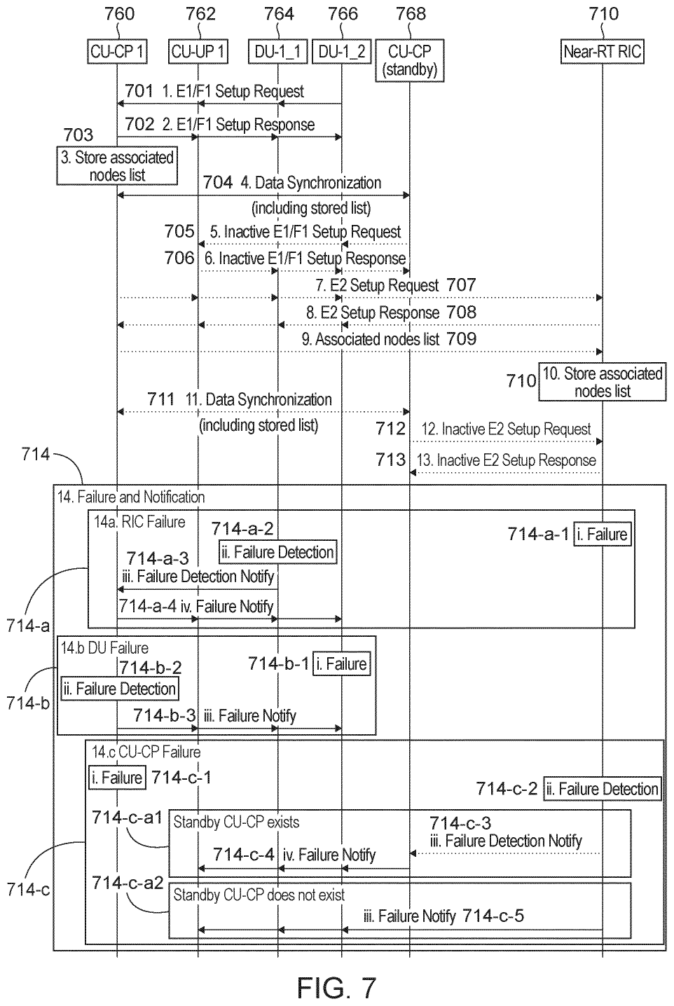

2. Notification via P2P interfaces in the current NG-RAN architecture (refer to FIG. 5). A central entity (gNB-CU-CP, Near-RT RIC, Non-RT RIC, SMO, OAM) can store a list (501) of associated NG-RAN Node logical entities/E2 Nodes. The list contains the unique IDs of the associated NG-RAN Node logical entities/E2 Nodes, assigned during interface establishment and/or a node configuration update procedures. Upon failure detection (502-a, 502-b, 502-c), the entity that detected the failure notifies the central entity about the failure (503-a, 503-b). The central entity sends a failure notification to the list (504-a, 504-b, 504-c) over the respective interface (E2/E1/F1/Xn/NG/X2). In the case of a NG-RAN Node logical entity failure, in case of a gNB-DU or gNB-CU-UP failure, the serving gNB-CU-CP sends a failure notification to all NG-RAN Node logical entities (e.g. 504-a, 504-b). In case of CU-CP failure, the failure detecting node shall notify the standby CU-CP (503-b), if the standby CU-CP exists. The standby CU-CP shall use the INACTIVE interfaces that may have already been setup to notify the rest of the associated nodes (504-c). A new message is proposed for such failure detection notification. This notification message contains necessary information to notify the associated nodes of the detected failure and is sent prior to any message indicating an operational switchover to the standby CU-CP 534-2. The notification message sent by the standby CU-CP 534-2 in the case of CU-CP failure is discussed further herein with reference to item 714-c-4 of FIG. 7. If standby CU-CP does not exist, the failure detecting node shall notify the Near-RT RIC (510), upon which Near-RT RIC shall use the E2 interface to notify the associated nodes (504-c) that have established E2 interfaces with the Near-RT RIC (510). In the case of Near-RT RIC failure, the serving gNB-CU-CP sends a failure notification to all E2 nodes in the E2 Node List over E1/F1/Xn/NG/X2 interfaces (e.g. 504-a, 504-b).

As further shown in FIG. 5, included in the NG-RAN architecture is a near-RT RIC 510, a CU E2 node 534, a standby CU E2 node 534-2, and a DU E2 node 534-3. The near-RT RIC 510 comprises an O1 termination 522, an A1 termination 524, common framework functions 528, a database 529, and an E2 termination 530. The near-RT RIC 510 hosts one or more xApps 518. As shown in FIG. 5, each of the E2 nodes comprises an O1 termination (536, 536-2, 536-3), an E2 agent (538, 538-2, 538-3), one or more E2 functions (540, 540-2, 540-3), and one or more non-E2 functions (542, 542-2, 542-3). Also shown in FIG. 5 is the E2 interface 532 that connects the near-RT RIC 510 and the CU E2 node, the E2 interface 532-2 that connects the near-RT RIC 510 with the DU E2 Node 534-3, the inactive E2 interface 532-3 that connects the near-RT RIC 510 and the standby CU E2 node 534-2, the E1/F1 interface 598 that connects the CU E2 node 534 with the DU E2 Node 534-3, and the inactive E1/F1 interface 598-2 that connects the standby CU E2 node 534-2 with the DU E2 node 534-3.

In the context of FIG. 5, interface establishment may occur in several different ways. For example, interface establishment may comprise a distributed unit establishing a control plane interface with the central unit control plane entity, or the distributed unit establishing a user plane interface with a central unit user plane entity, or the distributed unit changing to the central unit user plane entity or the distributed unit adding the central unit user plane entity, or the central unit control plane entity establishing a control plane interface with another central unit control plane entity, or the central unit control plane entity establishing a control plane interface with an access and mobility management function.

The central unit control plane entity may receive an indication of the distributed unit changing to the central unit user plane entity or the distributed unit adding the central unit user plane entity, and/or an indication of a second central unit control plane entity initiating a change to a third central unit control plane entity, or the central unit control plane entity releasing the established interface or a changing of an access and mobility management function.

The central unit control plane entity may update the associated node list with the distributed unit changing to the central unit user plane entity or the distributed unit adding the central unit user plane entity, or the second central unit control plane entity initiating the change to the third central unit control plane entity, or the central unit control plane entity releasing the established interface or the changing of the access and mobility management function.

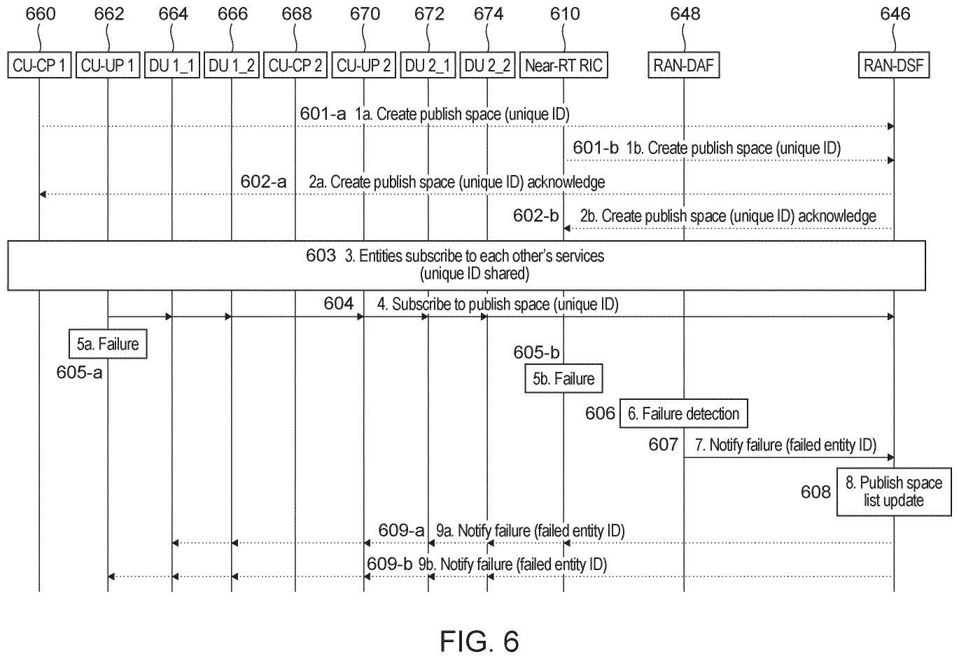

Details on the above-mentioned solution are provided further herein, with reference to FIG. 6 and FIG. 7.

### gNB Resiliency in SB-RAN Architecture

FIG. 6 shows an example message sequence diagram of the proposed solution for SB-RAN extensions. The method can be outlined as follows:
1. (601-a, 601-b) The central entity creates a notification publish space with a unique ID at the PAN DSF 646. The central entity can be (a) the CU-CP (e.g. 660), or (b) the Near-RT RIC 610, etc. for NG-RAN Node logical entity/E2 Node failure or Near-RT RIC, respectively.
2. (602-a, 602-b) The PAN DSF 646 creates the publish space and sends an acknowledgment to the central entity (e.g. to CU-CP 1 660 or to near-RT RIC 610).
3. (603) Entities (CU-CP 1 660, CU-UP 1 662, DU 1_1 664, Du 1_2 666, CU-CP 2 668, CU-UP 2 670, DU 2_1 672, DU 2_2 674, Near-RT RIC 610, RAN-DAF 648, RAN-DSF 646) subscribe to each other's services via a subscription request over the defined SBI APIs (e.g. DU 1_1 664 subscribes to cell management-related services of CU-CP 1 660, DU 2_1 672 subscribes to cell management-related services of CU-CP 2 668, etc.). The central entity (e.g. CU-CP 1 660 or near-RT RIC 610) shares the publish space unique ID when acknowledging the service subscription request.
4. (604) Entities that received the unique ID subscribe to the corresponding publish space at the PAN DSF 646.
5. (605-a, 605-b) Failure occurs in an entity, namely (a) CU-UP 1 662 and (b) Near-RT RIC 610.
6. (606) PAN DAF 648 detects the failure, using the previously collected failure statistics and any other useful information stored at PAN DSF 646. It is noted that failure detection can be performed by any other permitted entity. Failure detection can be done in various ways (service response timer expiries, data transmission over connection timer expiries, (AI/ML) mechanisms indicating probability of failure at a given time or time period, etc.) and additional mechanisms can be integrated to avoid false failure detection (multiple reports from one or more entities, AI/ML models, etc.).
7. (607) PAN DAF 648 notifies the RAN-DSF 646 of the failure, via a related message, such as Failure Notify containing necessary information indicating the failed entity and its identification.
8. (608) PAN DSF 646 updates the corresponding entry with the failure information.
9. (609-a, 609-b) PAN DSF 646 notifies the publish space about the failure. Notification can be done via a related message, such as Failure Notify.

The failure can relate to one or more xApps in the Near-RT RIC 610 as well (e.g. 326 of near-RT RIC 310 of FIG. 3). In this case, the notification (including at either 607, 609-a, or 609-b) can be performed by including in the notification messages the failed xApps' information. This information can be used by the notified entities to determine the effect of the failure on the entity's operation and can decide to ignore the notification.

Additionally, the notified entities can be filtered depending on the failed E2 Node type. For example if a (O-)CU-CP (660, 668) failure is detected, all the (O-)CU-UPs (662, 670), (O-)DUs (664, 666, 672, 674) that consume the failed (O-)CU-(O-)CPs (660, 668) services can be notified. However if a (O-)DU (664, 666, 672, 674) failure is detected, this notification can be narrowed down to the serving (O-)CU-CP (660 or 668) and (O-)CU-UP (662 or 670) as well as any other (O-)CU-CP (660 or 668) and (O-)CU-UP (662 or 670) (in case of EN-DC/NR-DC) that are affected by the failure but not the other (O-)DUs (664, 666, 672, or 674) that are served by the same (O-)CU-CP (660 or 668).

This can save signaling latency and payload.

### gNB Resiliency in NR RAN Architecture

FIG. 7 shows an example message sequence diagram of the described solution for the current RAN architecture based on P2P interfaces. The method can be outlined as follows:
1. (701) NG-RAN node logical entities (760, 762, 764, 766) establish E1/F1/Xn/X2 interfaces via a setup request message with each other during which node IDs are established.
2. (702) E1/F1/Xn/X2 interface establishment is completed via setup response message between the logical entities. While the signaling diagram at 702 shows for example the CU-CP 1 760 establishing an interface with the CU-UP 1 762, the CU-CP 1 760 also establishes an interface with the DU 1_1 764 and the DU 1_2 766, etc. Thus each of 760, 762, 764, and 766 in some examples establishes an interface with each of the other interfaces within the set of interfaces, where the set of interfaces comprises each of items 760, 762, 764, and 766.
3. (703) CU-CP 760 stores this data (e.g. data related to items 701 and 702) and creates an associated nodes list to be used for failure notification. The list generated at 703 can be created and/or updated via node configuration procedures. In particular, the associated node(s) list is created and updated based on interface establishment and/or node configuration update procedures. For example, after a DU (e.g. DU_1_1) establishes an F1-C interface with a CU-CP (e.g. CU-CP 1) and an F1-U interface with a CU-UP (e.g. CU-UP 1), the DU may change its CU-UP or connect to an additional CU-UP. This update/change would be notified to the CU-CP (e.g. CU-CP 1) which CU-CP would then update the associated node list accordingly.
4. (704) If there exists a standby CU-CP 768, the serving CU-CP 760 synchronizes its data at the standby CU-CP 768. This data synchronization includes the stored associated nodes list.
5. (705) If there exists a standby CU-CP 768, the standby CU-CP 768 establishes inactive interfaces with the entities that the serving CU-CP 760 has established interfaces with via an E1/F1/Xn/X2 (inactive) request.
6. (706) If there exists a standby CU-CP 768, E1/F1/Xn/X2 (inactive) interfaces establishment is completed via a setup response message.
7. (707) NG-RAN node logical entities (760, 762, 764, 766) can establish an E2 interface with the Near-RT RIC 710 via an E2 setup request message.
8. (708) E2 interface establishment is completed via an E2 setup response message.
9. (709) If there is E2 interface establishment, the CU-CP 760 can share the associated nodes list with the Near-RT RIC 710, via either an existing procedure, such as an E2 node configuration update extended with a new IE including the associated nodes list or a new procedure, such as an associated nodes list notify message.
10. (710) The Near-RT RIC 710 stores this data (received at 709) and creates an associated nodes list to be used for failure notification.
11. (711) If there exists a standby CU-CP, the serving CU-CP 760 synchronizes its data at the standby CU-CP 768. This data synchronization includes the stored associated nodes list.
12. (712) If there exists a standby CU-CP, the standby CU-CP 768 establishes an inactive E2 interface with the Near-RT RIC 710 serving the current serving CU-CP 760 via an E2 setup (inactive) request.
13. (713) If there exists a standby CU-CP, E2 (inactive) interface establishment is completed via an E2 setup (inactive) response message between the near-RT RIC 710 and the standby CU-CP 768.
14. (714) Failure occurs in a network entity: (1) Near-RT RIC (714-a), (2) DU (714-b), or (3) CU-CP (714-c).
1. (i.) (714-a-1) Failure occurs in the Near-RT RIC 710. (ii.) (714-a-2) Failure is detected in this scenario by the gNB-DU 764. (iii.) (714-a-3) The detected failure is notified to the central entity, gNB-CU-CP 760, via a notification from the DU 1_1 764 to the CU-CP 1 760. This failure detection notification can be done via a failure detection notify message, including the failed node's identity and any other related information regarding the failure. (iv.) (714-a-4) The CU-CP 1 (e.g. a gNB-CU-CP) notifies the associated nodes list. This notification can be done via a failure notify message, including the failed node's identity and any other related information regarding the failure. This message (714-a-4) can be broadcast to the associated nodes list, where as shown in FIG. 7, the associated nodes list includes the CU-UP 1 762, the DU 1_1 764, and the DU 1_2 766.
2. (i.) (714-b-1) Failure occurs in the DU (e.g. DU 1_2 766 such as a gNB). (ii) (714-b-2) Failure is detected in this scenario by the CU-CP 1 760 (e.g. a gNB-CU-CP). (iii.) (714-b-3) The CU-CP 1 760 (e.g. a gNB-CU-CP) notifies the associated nodes list as described in (14.a.iv., 714-a-4), such as by transmitting a notification to the CU-UP 1 762, the DU 1_1 764, and the DU 1_2 766.
3. (i.) (714-c-1) Failure occurs in the CU-CP 1 760 (e.g. a gNB-CU-CP). (ii.) (714-c-2) Failure is detected in this scenario by the Near-RT RIC 710. If there exists a standby CU-CP (714-c-a1), (iii.) (714-c-3) the Near-RT RIC 710 notifies the standby CU-CP 768 about the CU-CP failure (714-c-1) as described in (14.a.iii., 714-a-3). However, in 714-c-3, the notifying entity of the failure to the standby CU-CP 768 does not have to be only the Near-RT RIC 710. It can be a DU (e.g. DU 1_1 764 or DU 1_2 766), CU-UP (e.g. CU-UP 1 762) etc. These entities (DU, CU-UP) also have inactive interfaces established towards the stand-by CU-CP 768. (iv.) (714-c-4) The standby CU-CP 768 notifies the list about the CU-CP failure as described in (14.a.iv., 714-a-4), including transmitting a notification to the DU 1_2 766, the DU 1_1 764, and the CU-UP 1 762. Thus, broadcasting to the associated node list is performed by standby CU-CP 768. If there does not exist a standby CU-CP (714-c-a2), at 714-c-5 the Near-RT RIC 710 notifies only the nodes in the associated nodes list that have established an E2 interface with the Near-RT RIC 710 as described in (14.a.iv., 714-a-4). In particular, in case there is no standby CU-CP, then the node that detected the failure notifies the Near-RT RIC 710 (If the node that detected the failure is not the Near-RT RIC 710 already). The Near-RT RIC 710 notifies the associated node list which only includes the ones that established E2 interfaces. In the example shown in FIG. 7, at 714-c-5 the Near-RT RIC 710 notifies the DU 1_2 766, the DU 1_1 764, and the CU-UP 1 762, where each have established E2 interfaces.

Failure detection (714-a-2, 714-b-2, 714-c-2) can be done in various ways (service response timer expiries, data transmission over connection timer expiries, (AI/ML) mechanisms indicating probability of failure at a given time or time period, etc.) and additional mechanisms can be integrated to avoid false failure detection (multiple reports from one or more entities, AI/ML models, etc.)

The failure can relate to one or more xApps in Near-RT RIC 710 as well (e.g. such as item 326 shown in FIG. 3). In this case, the notification can be performed by including in the notification messages the failed xApps' information. This information can be used by the notified entities to determine the effect of the failure on the entity's operation and can decide to ignore the notification.

Additionally, the notified entities can be filtered depending on the failed E2 Node type. For example if a (O-)CU-CP 760 failure is detected, all the (O-)CU-CPs, (O-)CU-UPs 762, (O-)DUs (764, 766) that are connected via E1/F1/Xn interfaces can be notified. However if a (O-)DU (764 or 766) failure is detected, this notification can be narrowed down to the serving (O-)CU-CP 760 and (O-)CU-UP 762 as well as any other (O-)CU-CP 760 and (O-)CU-UP 762 (in case of EN-DC/NR-DC) that are affected by the failure but not the other (O-)DUs (764 or 766) that are served by the same (O-)CU-CP 760.

The herein described SB-RAN solution may not rely on the Near-RT RIC as the central node. The role of central node is left as a new standalone function with both 3GPP NFs (DU, CU-CP, CU-UP, eNB, etc.) and ORAN Near-RT RIC all treated as just NFs that may fail. That is, the SB-RAN based solution does not rely on the Near-RT RIC or any central entity, since the failure detection could be performed by any eligible node and the notification is shared by the RAN-DSF. This standalone function could be also integrated into the CU-CP, or the Near-RT RIC, or the AMF.

In the NG-RAN with P2P interfaces solution, only the broadcast notification is coming from the central entity (i.e. the stand-by CU-CP). If the mesh of network interfaces was relied upon, then new C-plane interfaces may need to be introduced where none exists. For e.g.: A DU may detect CU-CP failure, but it does not have interfaces to the rest of the DUs or unconnected CU-UPs. Hence the broadcast is relayed via a stand-by CU-CP, who has C-plane interface with every other entity.

The examples herein describe the resilient and robust operation of a gNB with and without SB-RAN considerations as well as in O-RAN environments.

FIG. 8 is an example implementation of a radio node 834 (e.g. and O-eNB or an O-gNB, or an E2 node similar to E2 node 334, or a PAN node similar to item 170 of FIG. 1) suitable for an O-RAN environment. A CU-CP 860 (e.g. an O-CU-CP) is coupled to a CU-UP 862 (e.g. an O-CU-UP) via an E1 interface 804. The CU-CP 860 and the CU-UP 862 are coupled via an F1 interface (respectively F1 898-1 and F1 898-2) to the DU 864 (e.g. an O-DU), which DU 864 is coupled to the RU 880. The radio node 870 may be coupled to a RIC 810 via an E2 interface 832, which RIC 810 may be a near-RT RIC such as the near-RT RIC 310 as shown in FIG. 3.

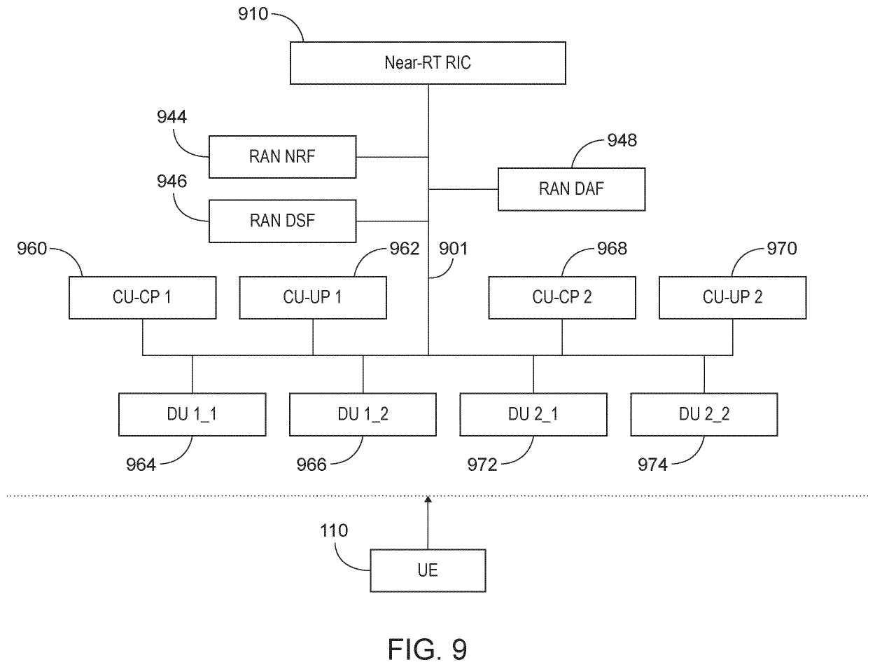

FIG. 9 is a block diagram depicting nodes within an SB-PAN architecture. FIG. 9 illustrates couplings of items of the message diagram of FIG. 6, and has a similar structure of the block diagram shown in FIG. 4. Shows are various items coupled items, coupled via interface 901, which interface 901 may be used as a medium for distribution of the publish space. Shown in FIG. 9 is the near-RT RIC 910, the RAN NRF 944, the RAN DSF 946, the PAN DAF 948, CU-CP 1 960, CU-UP 1 962, CU-CP 2 968, CU-UP 2, 970, DU 1_1 964, DU 1_2 966, DU 2_1 972, and DU 2_2 974. UE 110 accesses a communication network via at least the items shown in FIG. 9.

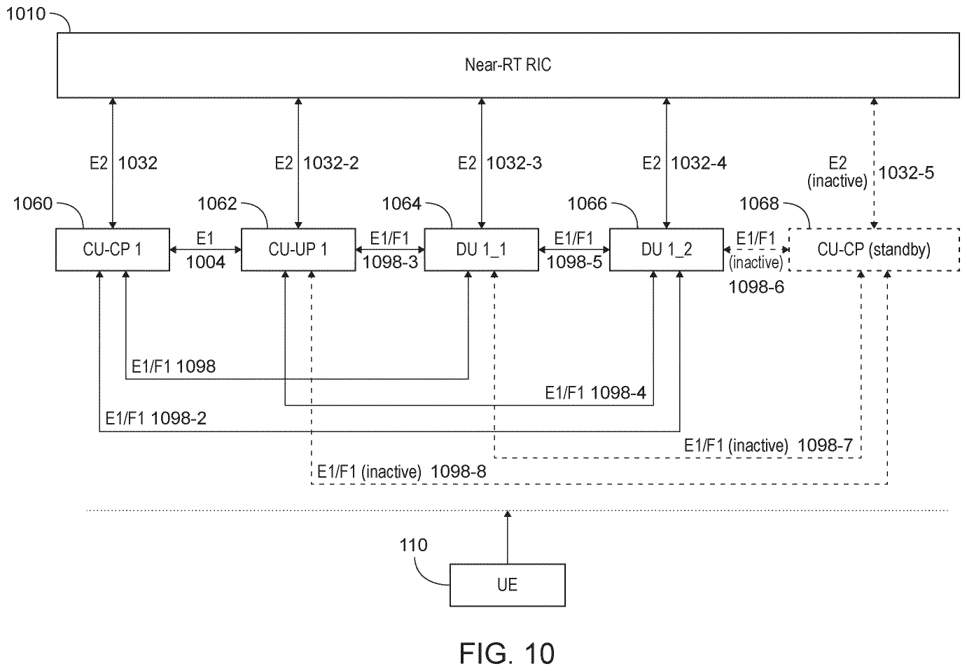

FIG. 10 is a block diagram depicting nodes within an NR PAN architecture. FIG. 10 illustrates couplings of items of the message diagram of FIG. 7, and has a similar structure of the block diagram shown in FIG. 5. The near-RT RIC 1010 is coupled to CU-CP 1 1060, CU-UP 1 1062, DU 1_1 1064 and DU 1_2 1066 via an E2 interface, respectively E2 interfaces 1032, 1032-2, 1032-3, and 1032-4. CU-CP 1 1060 is coupled to CU-UP 1062 via E1 interface 1004.

As further shown in FIG. 10, CU-CP 1 1060 is coupled to DU 1_1 1064 and DU 1_2 1066 via E1 or F1 interfaces 1098 and 1098-2, respectively. CU-UP 1 1062 is coupled to DU 1_1 1064 and DU 1_2 1066 via E1 or F1 interfaces 1098-3 and 1098-4, respectively. DU 1_1 1064 is coupled to DU 1_2 1066 via E1 or F1 interface 1098-5. Optionally included (optionality indicated with dashed lines) is standby CU-CP 1068. If standby CU-CP 1068 exists, standby CU-CP 1068 is coupled to the near-RT RIC 1010 via inactive E2 interface 1032-5, and is further coupled to DU 1_2 1066 via inactive E1 or F1 interface 1098-6, to DU 1_1 1064 via inactive E1 or F1 interface 1098-7, and to CU-UP 1 1062 via inactive E1 or F1 interface 1098-8. UE 110 accesses a communication network via at least the items shown in FIG. 10.

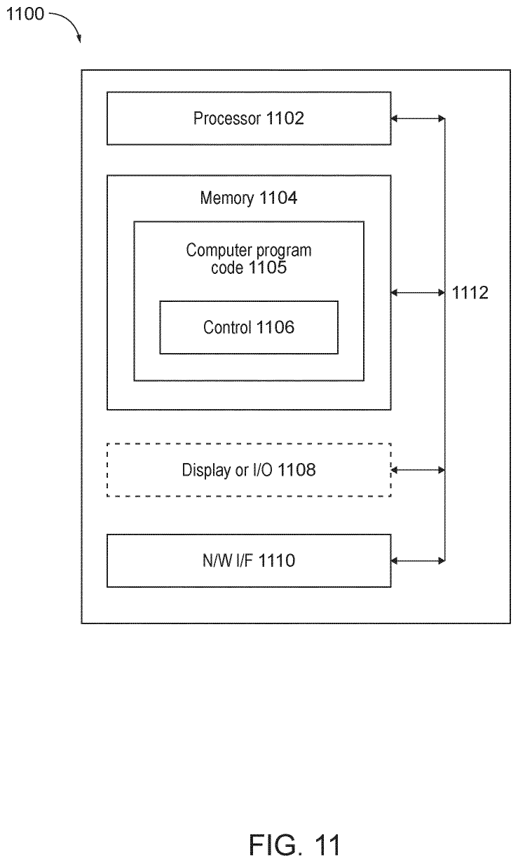

FIG. 11 is an example apparatus 1100, which may be implemented in hardware, configured to implement the examples described herein. The apparatus 1100 comprises at least one processor 1102 (e.g. an FPGA and/or CPU), at least one memory 1104 including computer program code 1105, wherein at least one memory 1104 and the computer program code 1105 are configured to, with at least one processor 1102, cause the apparatus 1100 to implement circuitry, a process, component, module, or function (collectively control 1106) to implement the examples described herein, including optimization of gNB failure detection and fast activation of fallback mechanism. The memory 1104 may be a non-transitory memory, a transitory memory, a volatile memory, or a non-volatile memory.

The apparatus 1100 optionally includes a display and/or I/O interface 1108 that may be used to display aspects or a status of the methods described herein (e.g., as one of the methods is being performed or at a subsequent time), or to receive input from a user such as with using a keypad. The apparatus 1100 includes one or more network (N/W) interfaces (I/F(s)) 1110. The N/W I/F(s) 1110 may be wired and/or wireless and communicate over the Internet/other network(s) via any communication technique. The N/W I/F(s) 1110 may comprise one or more transmitters and one or more receivers. The N/W I/F(s) 1110 may comprise standard well-known components such as an amplifier, filter, frequency-converter, (de)modulator, and encoder/decoder circuitries and one or more antennas.

The apparatus 1100 to implement the functionality of control 116 may be UE 110, PAN node 170, network element(s) 190, network element(s) 189 or any of the apparatuses depicted in FIG. 2, FIG. 3, FIG. 4, FIG. 5, FIG. 6, FIG. 7, FIG. 8, FIG. 9, and/or FIG. 10. Accordingly the apparatus 1100 may be any NG-RAN logical entity (e.g., CU-CP, DU, CU-UP, gNB-CU-CP, gNB-DU, gNB-CU-UP) or E2 Node in O-RAN, a near-RT RIC, or a RAN DSF.

Thus, processor 1102 may correspond respectively to processor(s) 120, processor(s) 152, processor(s) 175, and/or processor(s) 172, memory 1104 may correspond respectively to memory(ies) 125, memory(ies) 155, memory(ies) 171, and/or memory(ies) 177, computer program code 1105 may correspond respectively to computer program code 123, module 121-1, module 121-2, and/or computer program code 153, module 156-1, module 156-2, RIC module 150-1, RIC module 150-2, computer program code 173, RIC module 140-1, RIC module 140-2, and/or computer program code 179, and N/W I/F(s) 1110 may correspond respectively to transceiver 130, N/W I/F(s) 161, N/W I/F(s) 180, and/or N/W I/F(s) 174.

Alternatively, apparatus 1100 may not correspond to either of UE 110, PAN node 170, network element(s) 190, or network element(s) 189 as apparatus 1100 may be part of a self-organizing/optimizing network (SON) node, such as in a cloud. The apparatus 1100 may also be distributed throughout the network 100 including within and between apparatus 1100 and any network element (such as a network control element (NCE) 190 and/or network element(s) 189 and/or the PAN node 170 and/or the UE 110).

Interface 1112 enables data communication between the various items of apparatus 1100, as shown in FIG. 11. For example, the interface 1112 may be one or more buses such as address, data, or control buses, and may include any interconnection mechanism, such as a series of lines on a motherboard or integrated circuit, fiber optics or other optical communication equipment, and the like. Computer program code 1105, including control 1106 may comprise object-oriented software configured to pass data/messages between objects within computer program code 1105. The apparatus 1100 need not comprise each of the features mentioned, or may comprise other features as well.

Apparatus 1100 may function as a 3GPP node (UE, base station e.g. eNB or gNB, network element) or as an O-RAN node (UE, disaggregated eNB or gNB, or network element).

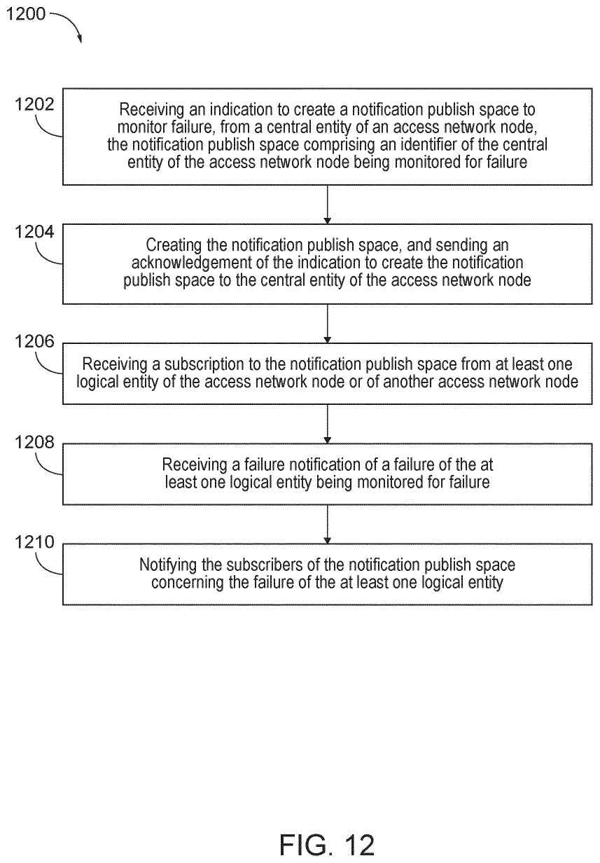

FIG. 12 is an example method 1200 to implement the example embodiments described herein. At 1202, the method includes receiving an indication to create a notification publish space to monitor failure, from a central entity of an access network node, the notification publish space comprising an identifier of the central entity of the access network node being monitored for failure. At 1204, the method includes creating the notification publish space, and sending an acknowledgement of the indication to create the notification publish space to the central entity of the access network node. At 1206, the method includes receiving a subscription to the notification publish space from at least one logical entity of the access network node or of another access network node. At 1208, the method includes receiving a failure notification of a failure of the at least one logical entity being monitored for failure. At 1210, the method includes notifying the subscribers of the notification publish space concerning the failure of the at least one logical entity. Method 1200 may be performed with a RAN DSF.

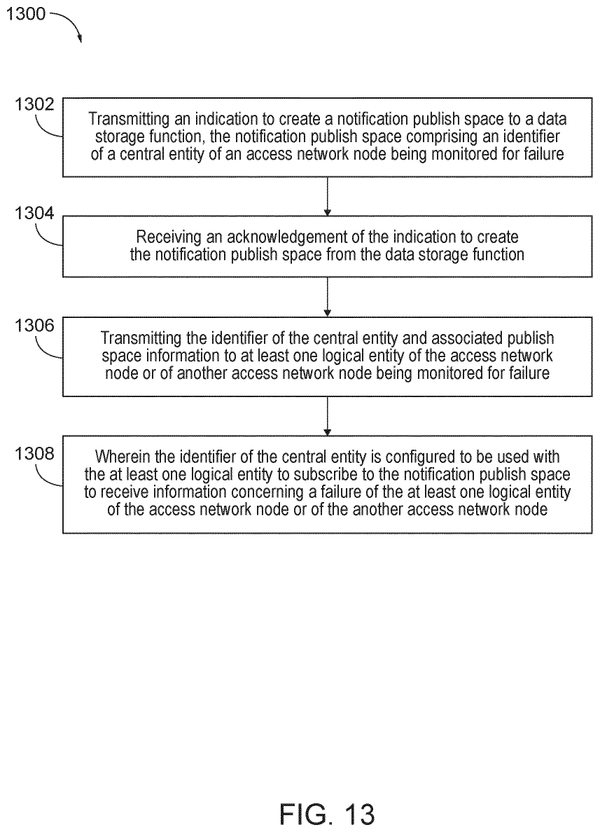

FIG. 13 is an example method 1300 to implement the example embodiments described herein. At 1302, the method includes transmitting an indication to create a notification publish space to a data storage function, the notification publish space comprising an identifier of a central entity of an access network node being monitored for failure. At 1304, the method includes receiving an acknowledgement of the indication to create the notification publish space from the data storage function. At 1306, the method includes transmitting the identifier of the central entity and associated publish space information to at least one logical entity of the access network node or of another access network node being monitored for failure. At 1308, the method includes wherein the identifier of the central entity is configured to be used with the at least one logical entity to subscribe to the notification publish space to receive information concerning a failure of the at least one logical entity of the access network node or of the another access network node. Method 1300 may be performed with an SB-PAN central entity.

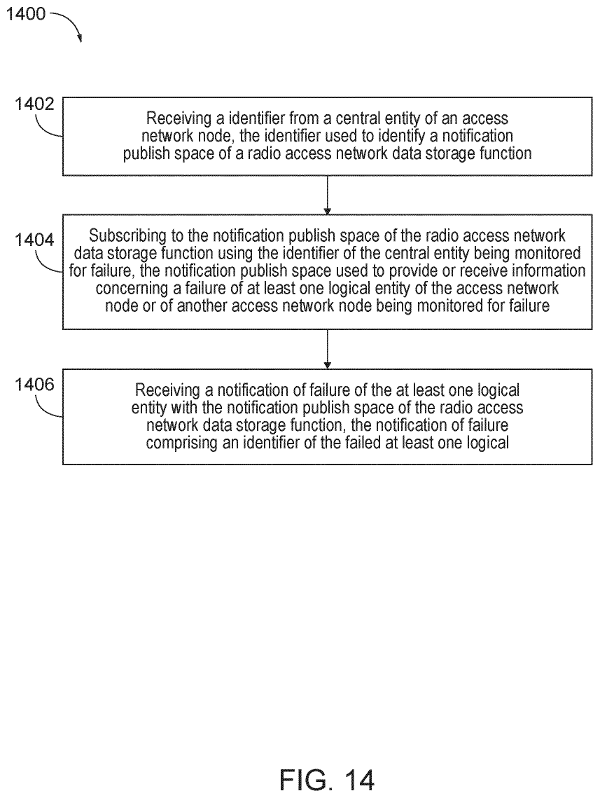

FIG. 14 is an example method 1400 to implement the example embodiments described herein. At 1402, the method includes receiving a identifier from a central entity of an access network node, the identifier used to identify a notification publish space of a radio access network data storage function. At 1404, the method includes subscribing to the notification publish space of the radio access network data storage function using the identifier of the central entity being monitored for failure, the notification publish space used to provide or receive information concerning a failure of at least one logical entity of the access network node or of another access network node being monitored for failure. At 1406, the method includes receiving a notification of failure of the at least one logical entity with the notification publish space of the radio access network data storage function, the notification of failure comprising an identifier of the failed at least one logical entity. Method 1400 may be performed with an SB-RAN logical entity.

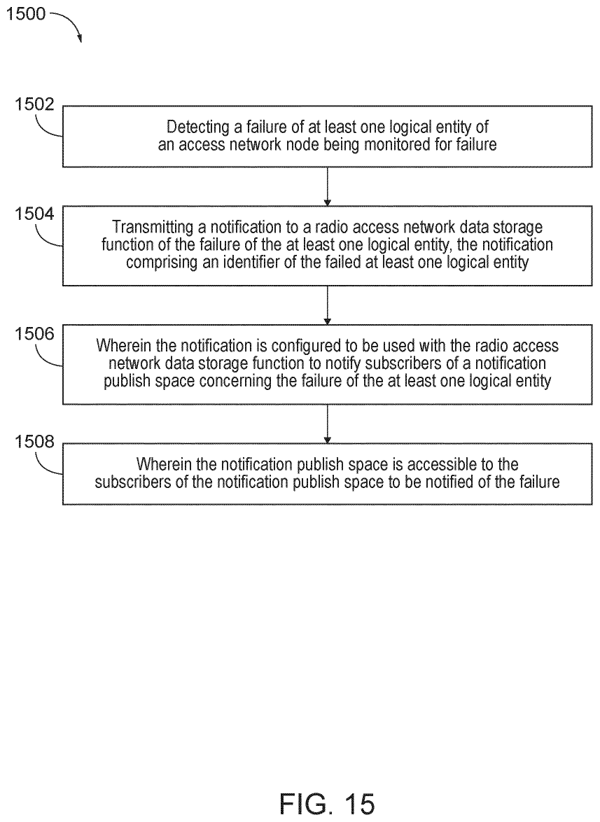

FIG. 15 is an example method 1500 to implement the example embodiments described herein. At 1502, the method includes detecting a failure of at least one logical entity of an access network node being monitored for failure. At 1504, the method includes transmitting a notification to a radio access network data storage function of the failure of the at least one logical entity, the notification comprising an identifier of the failed at least one logical entity. At 1506, the method includes wherein the notification is configured to be used with the radio access network data storage function to notify subscribers of a notification publish space concerning the failure of the at least one logical entity. At 1508, the method includes wherein the notification publish space is accessible to the subscribers of the notification publish space to be notified of the failure. Method 1500 may be performed with an SB-RAN DAF.

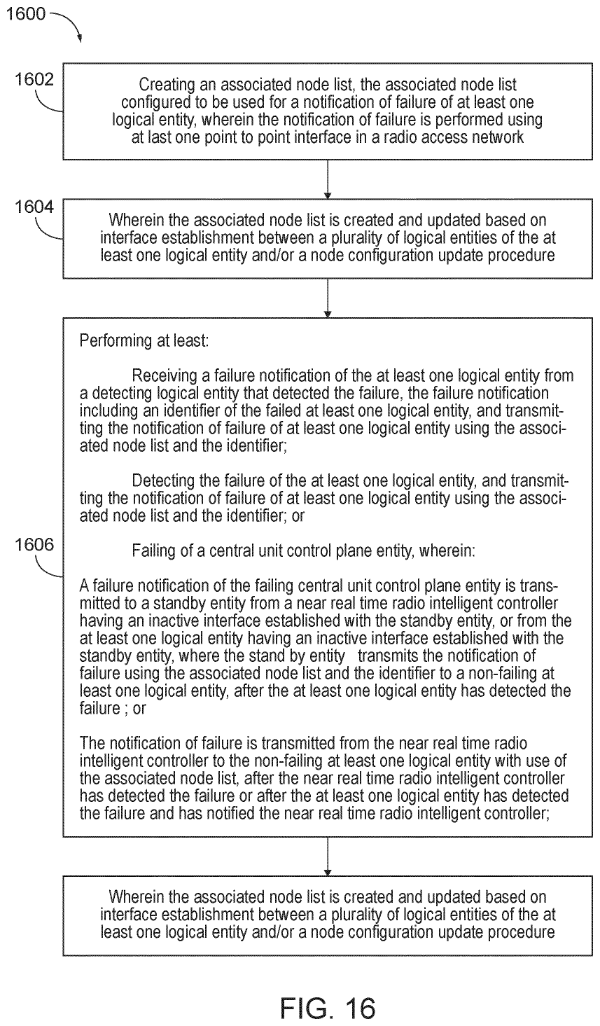

FIG. 16 is an example method 1600 to implement the example embodiments described herein. At 1602, the method includes creating an associated node list, the associated node list configured to be used for a notification of failure of at least one logical entity, wherein the notification of failure is performed using at last one point to point interface in a radio access network. At 1604, the method includes wherein the associated node list is created and updated based on interface establishment between a plurality of logical entities of the at least one logical entity and/or a node configuration update procedure. At 1606, the method includes performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller. At 1608, the method includes wherein the at least one logical entity, the plurality of logical entities, the central unit control plane entity, the standby entity, and the non-failing at least one logical entity are entities of at least one access network node. Method 1600 may be performed with an NR RAN CU-CP.

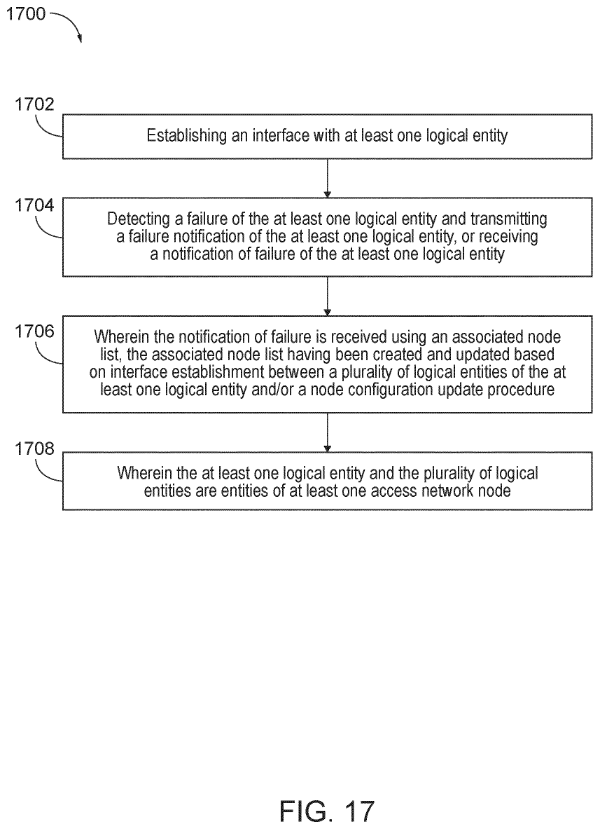

FIG. 17 is an example method 1700 to implement the example embodiments described herein. At 1702, the method includes establishing an interface with at least one logical entity. At 1704, the method includes detecting a failure of the at least one logical entity and transmitting a failure notification of the at least one logical entity, or receiving a notification of failure of the at least one logical entity. At 1706, the method includes wherein the notification of failure is received using an associated node list, the associated node list having been created and updated based on interface establishment between a plurality of logical entities of the at least one logical entity and/or a node configuration update procedure. At 1708, the method includes wherein the at least one logical entity and the plurality of logical entities are entities of at least one access network node. Method 1700 may be performed with an NR-RAN logical entity.

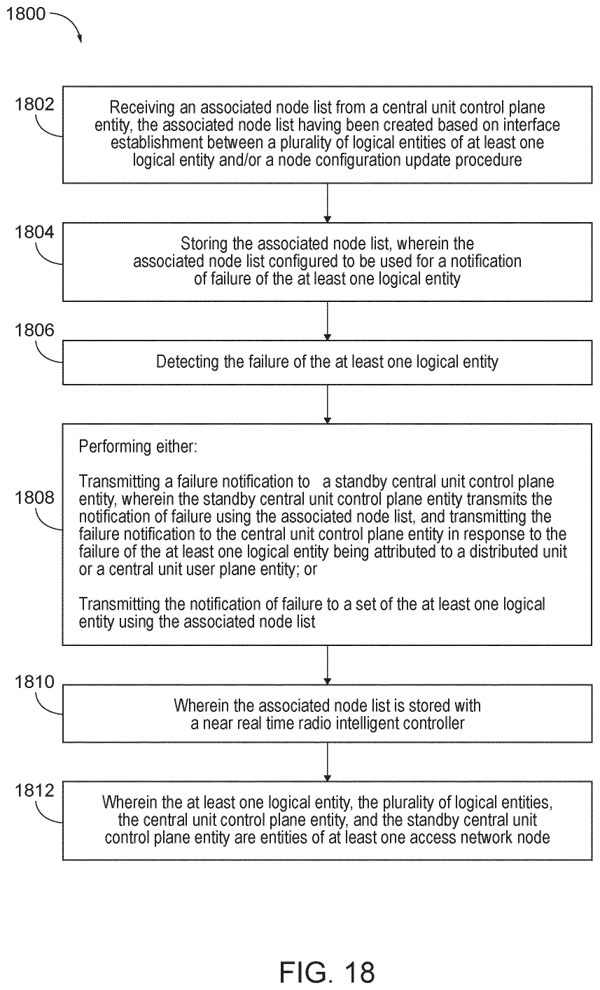

FIG. 18 is an example method 1800 to implement the example embodiments described herein. At 1802, the method includes receiving an associated node list from a central unit control plane entity, the associated node list having been created based on interface establishment between a plurality of logical entities of at least one logical entity and/or a node configuration update procedure. At 1804, the method includes storing the associated node list, wherein the associated node list configured to be used for a notification of failure of the at least one logical entity. At 1806, the method includes detecting the failure of the at least one logical entity. At 1808, the method includes performing either: transmitting a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmitting the notification of failure to a set of the at least one logical entity using the associated node list. At 1810, the method includes wherein the associated node list is stored with a near real time radio intelligent controller. At 1812, the method includes wherein the at least one logical entity, the plurality of logical entities, the central unit control plane entity, and the standby central unit control plane entity are entities of at least one access network node. Method 1800 may be performed with an NR RAN near-RT RIC.

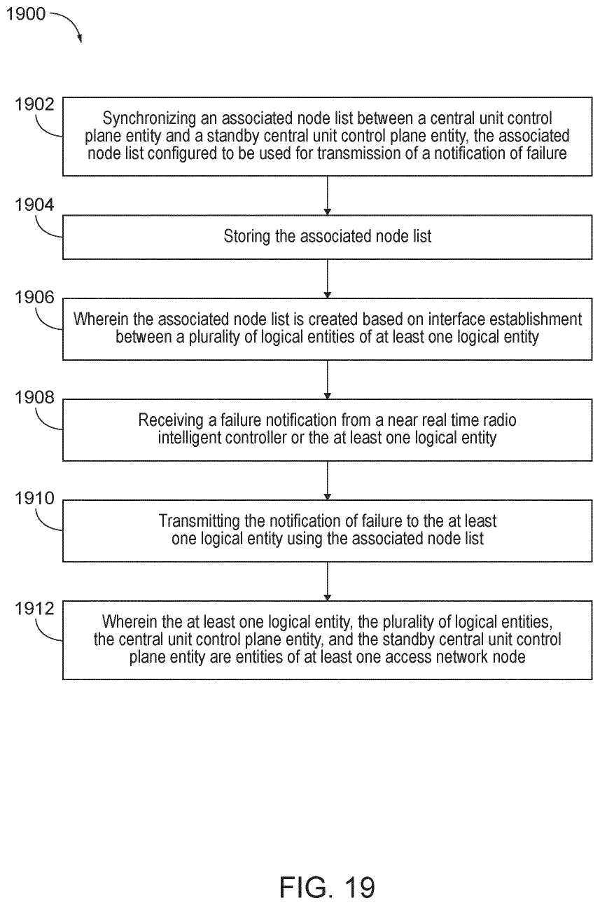

FIG. 19 is an example method 1900 to implement the example embodiments described herein. At 1902, the method includes synchronizing an associated node list between a central unit control plane entity and a standby central unit control plane entity, the associated node list configured to be used for transmission of a notification of failure. At 1904, the method includes storing the associated node list. At 1906, the method includes wherein the associated node list is created based on interface establishment between a plurality of logical entities of at least one logical entity. At 1906, the method includes receiving a failure notification from a near real time radio intelligent controller or the at least one logical entity. At 1908, the method includes transmitting the notification of failure to the at least one logical entity using the associated node list. At 1910, the method includes wherein the at least one logical entity, the plurality of logical entities, the central unit control plane entity, and the standby central unit control plane entity are entities of at least one access network node. Method 1900 may be performed with a standby CU-CP.

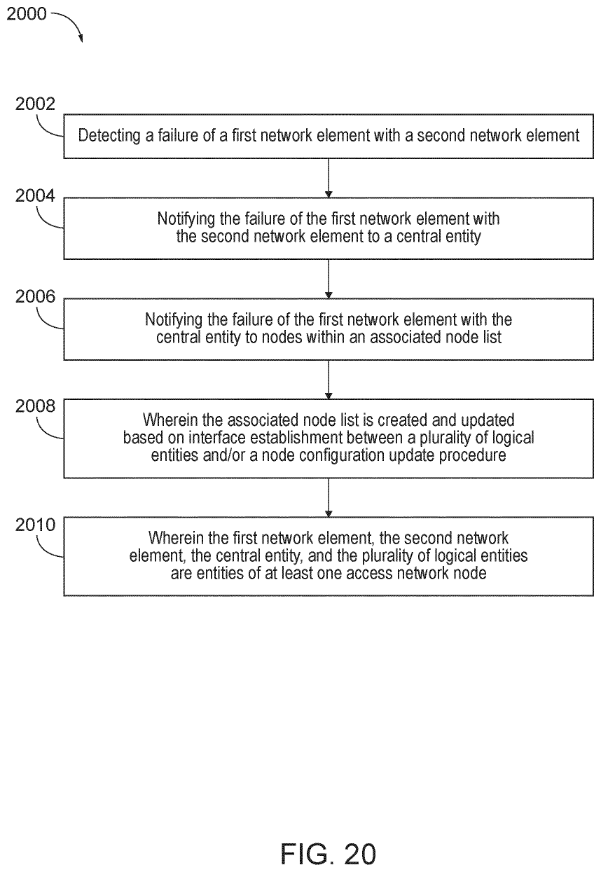

FIG. 20 is an example method 2000 to implement the example embodiments described herein. At 2002, the method includes detecting a failure of a first network element with a second network element. At 2004, the method includes notifying the failure of the first network element with the second network element to a central entity. At 2006, the method includes notifying the failure of the first network element with the central entity to nodes within an associated node list. At 2008, the method includes wherein the associated node list is created and updated based on interface establishment between a plurality of logical entities and/or a node configuration update procedure. At 2010, the method includes wherein the first network element, the second network element, the central entity, and the plurality of logical entities are entities of at least one access network node. Method 2000 may be performed within a NG-PAN P2P context.

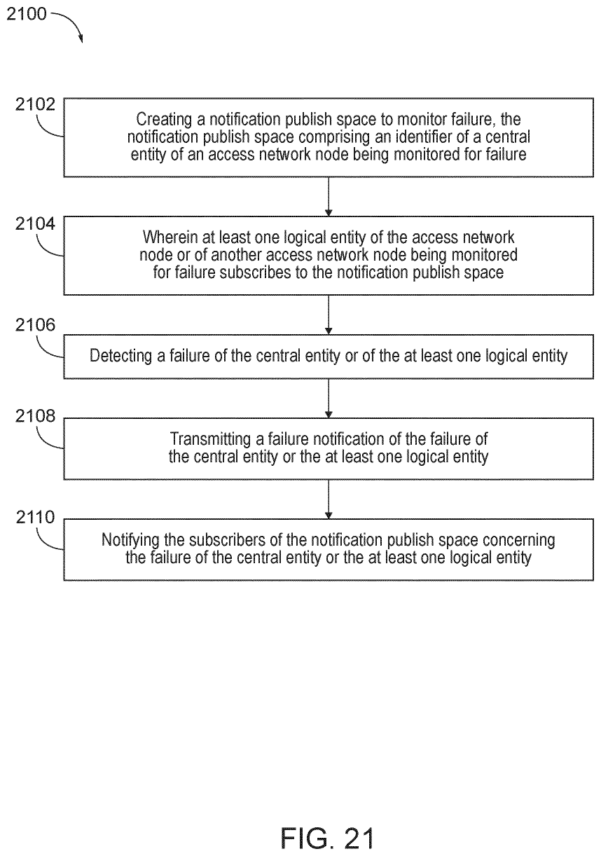

FIG. 21 is an example method 2100 to implement the example embodiments described herein. At 2102, the method includes creating a notification publish space to monitor failure, the notification publish space comprising an identifier of a central entity of an access network node being monitored for failure. At 2104, the method includes wherein at least one logical entity of the access network node or of another access network node being monitored for failure subscribes to the notification publish space. At 2106, the method includes detecting a failure of the central entity or of the at least one logical entity. At 2108, the method includes transmitting a failure notification of the failure of the central entity or the at least one logical entity. At 2110, the method includes notifying the subscribers of the notification publish space concerning the failure of the central entity or the at least one logical entity. Method 2100 may be performed within an SB-RAN context.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The following examples 1 to 160 are provided and described, which are based on the example embodiments described herein.

Example 1: An example method includes receiving an indication to create a notification publish space to monitor failure, from a central entity of an access network node, the notification publish space comprising an identifier of the central entity of the access network node being monitored for failure; creating the notification publish space, and sending an acknowledgement of the indication to create the notification publish space to the central entity of the access network node; receiving a subscription to the notification publish space from at least one logical entity of the access network node or of another access network node; receiving a failure notification of a failure of the at least one logical entity being monitored for failure; and notifying the subscribers of the notification publish space concerning the failure of the at least one logical entity.

Example 2: The method of example 1, wherein the failure notification of the failure comprises an identifier of the failed at least one logical entity.

Example 3: The method of any of examples 1 to 2, wherein the notifying the subscribers of the notification publish space concerning the failure of the at least one logical entity comprises transmitting an identifier of the failed at least one logical entity to the subscribers of the notification publish space.

Example 4: The method of any of examples 1 to 3, wherein the at least one logical entity subscribes to the notification publish space in response to having received an identifier of the central entity and associated publish space information.

Example 5: The method of any of examples 1 to 4, further comprising updating a publish space list with information concerning the failure of the at least one logical entity.

Example 6: The method of any of examples 1 to 5, wherein the notification publish space is created with a data storage function.

Example 7: The method of any of examples 1 to 6, further comprising detecting the failure of the at least one logical entity.

Example 8: The method of any of examples 1 to 7, wherein the failed at least one logical entity comprises one or more services of a near real time radio intelligent controller.

Example 9: The method of example 8, wherein the notifying the subscribers of the notification publish space concerning the failure of the at least one logical entity comprises providing information concerning the one or more services of the near real time radio intelligent controller.

Example 10: The method of any of examples 1 to 9, wherein the failed at least one logical entity comprises one or more services of the at least one logical entity.

Example 11: The method of example 10, wherein the notifying the subscribers of the notification publish space concerning the failure of the at least one logical entity comprises providing information concerning the failure of the one or more services of the at least one logical entity, or providing information concerning the at least one logical entity.

Example 12: The method of any of examples 10 to 11, wherein the at least one logical entity comprises a distributed unit, a central unit user plane entity, or a central unit control plane entity.

Example 13: The method of any of examples 1 to 12, further comprising filtering the at least one logical entity prior to notifying the notification publish space concerning the failure of the at least one logical entity, such that a first subset of the at least one logical entity receives the notification of the failure, and a second subset of the at least one logical entity does not receive the notification of the failure due to not being affected with the failure.

Example 14: The method of any of examples 1 to 13, wherein the central entity comprises either a central unit control plane entity or a near real time radio intelligent controller.

Example 15: The method of any of examples 1 to 14, wherein the at least one logical entity, including the failed at least one logical entity, comprises: a central unit control plane entity; a central unit user plane entity; a distributed unit; or a near real time radio intelligent controller.

Example 16: An example method includes transmitting an indication to create a notification publish space to a data storage function, the notification publish space comprising an identifier of a central entity of an access network node being monitored for failure; receiving an acknowledgement of the indication to create the notification publish space from the data storage function; and transmitting the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node.

Example 17: The method of example 16, wherein the central entity comprises either a central unit control plane entity or a near real time radio intelligent controller.

Example 18: The method of any of examples 16 to 17, further comprising: detecting the failure of the at least one logical entity of the access network node or of the another access network node; and notifying a data storage function of the failure, the notifying comprising including an identifier of the failed at least one logical entity.

Example 19: The method of example 18, wherein detecting the failure is performed with at least one of: at least one service response timer expiry; at least one transport network failure detection timer expiry; or an artificial intelligence or machine learning method indicating a probability of failure at a given time or time period.

Example 20: The method of any of examples 18 to 19, further comprising filtering the at least one logical entity prior to notifying the data storage function of the failure of the at least one logical entity, such that a first subset of the at least one logical entity receives a failure notification, and a second subset of the at least one logical entity does not receive the failure notification.

Example 21: The method of any of examples 16 to 20, further comprising subscribing to the notification publish space.

Example 22: The method of any of examples 16 to 21, further comprising detecting falsely identified failures.

Example 23: The method of example 22, wherein detecting falsely identified failures comprises at least one of: integrating reports from multiple of the at least one logical entity; or an artificial intelligence or machine learning model.

Example 24: An example method includes receiving a identifier from a central entity of an access network node, the identifier used to identify a notification publish space of a radio access network data storage function; subscribing to the notification publish space of the radio access network data storage function using the identifier of the central entity being monitored for failure, the notification publish space used to provide or receive information concerning a failure of at least one logical entity of the access network node or of another access network node being monitored for failure; and receiving a notification of failure of the at least one logical entity with the notification publish space of the radio access network data storage function, the notification of failure comprising an identifier of the failed at least one logical entity.

Example 25: The method of claim 24, further comprising: detecting the failure of the at least one logical entity; and notifying a data storage function of the failure, the notifying comprising including an identifier of the failed at least one logical entity.

Example 26: The method of example 25, wherein detecting the failure is performed with at least one of: at least one service response timer expiry; at least one transport network failure detection timer expiry; or an artificial intelligence or machine learning method indicating a probability of failure at a given time or time period.

Example 27: The method of any of examples 25 to 26, further comprising filtering the at least one logical entity prior to notifying the data storage function of the failure of the at least one logical entity, such that a first subset of the at least one logical entity receives a failure notification, and a second subset of the at least one logical entity does not receive the failure notification due to not being affected with the failure.

Example 28: The method of any of examples 24 to 27, wherein the central entity comprises either a central unit control plane entity or a near real time radio intelligent controller.

Example 29: The method of any of examples 24 to 28, wherein the at least one logical entity comprises: a central unit control plane entity; a central unit user plane entity; a distributed unit; or a near real time radio intelligent controller.

Example 30: An example method includes detecting a failure of at least one logical entity of an access network node being monitored for failure; and transmitting a notification to a radio access network data storage function of the failure of the at least one logical entity, the notification comprising an identifier of the failed at least one logical entity; wherein the notification is configured to be used with the radio access network data storage function to notify subscribers of a notification publish space concerning the failure of the at least one logical entity; wherein the notification publish space is accessible to the subscribers of the notification publish space to be notified of the failure.

Example 31: The method of example 30, wherein detecting the failure comprises utilizing previously collected failure statistics and other information stored within a radio access network data storage function.

Example 32: The method of any of examples 30 to 31, wherein detecting the failure is performed with at least one of: at least one service response timer expiry; at least one transport network failure detection timer expiry; or an artificial intelligence or machine learning method indicating a probability of failure at a given time or time period.

Example 33: The method of any of examples 30 to 32, further comprising detecting falsely identified failures.

Example 34: The method of example 33, wherein detecting falsely identified failures comprises at least one of: integrating reports from multiple of the at least one logical entity; or an artificial intelligence or machine learning model.

Example 35: An example method includes creating an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

Example 36: The method of example 35, further comprising: receiving, with the central unit control plane entity, an indication of an addition or change related to the interface establishment; and updating, with the central unit control plane entity, the associated node list with the addition or change related to the interface establishment.

Example 37: The method of any of examples 35 to 36, wherein the associated node list is created with the central unit control plane entity.

Example 38: The method of any of examples 35 to 37, further comprising synchronizing the associated node list with the standby entity, wherein the standby entity comprises a standby central unit control plane entity.

Example 39: The method of any of examples 35 to 38, further comprising transmitting the associated node list to the near real time radio intelligent controller for storage.

Example 40: The method of any of examples 35 to 39, wherein the associated node list is transmitted to the near real time radio intelligent controller using an interface node configuration update extended with an information element including the associated node list.

Example 41: The method of any of examples 35 to 40, wherein the associated node list is transmitted to the near real time radio intelligent controller using an associated node list notify procedure.

Example 42: The method of any of examples 35 to 41, wherein the receiving of the failure notification of the at least one logical entity from the detecting logical entity that detected the failure occurs in response to a failure of the near real time radio intelligent controller.

Example 43: The method of any of examples 35 to 42, wherein the detecting logical entity comprises another entity.

Example 44: The method of any of examples 35 to 43, further comprising receiving the failure notification of the at least one logical entity in response to detection of the failure with another entity.

Example 45: The method of example 44, further comprising receiving the failure notification of the at least one logical entity from the another entity.

Example 46: The method of any of examples 35 to 45, further comprising: receiving the failure notification of the at least one logical entity in response to detection of the failure with a distributed unit; and receiving the failure notification of the at least one logical entity from the distributed unit.

Example 47: The method of any of examples 35 to 46, wherein the failing of the central unit control plane entity is detected with another entity.

Example 48: The method of any of examples 35 to 47, wherein the failing of the central unit control plane entity is detected with the near real time radio intelligent controller.

Example 49: The method of example 48, wherein the failing of the central unit control plane entity is detected with the near real time radio intelligent controller via an E2 interface.

Example 50: The method of any of examples 35 to 49, wherein the failing of the central unit control plane entity is detected with a distributed unit.

Example 51: The method of example 50, wherein the failing of the central unit control plane entity is detected with the distributed unit via an F1 interface.

Example 52: The method of any of examples 35 to 51, wherein the failing of the central unit control plane entity is detected with a central unit user plane entity.

Example 53: The method of example 52, wherein the failing of the central unit control plane entity is detected with the central unit user plane entity via an E1 interface.

Example 54: The method of any of examples 35 to 53, wherein the failing of the central unit control plane entity is detected with another central unit control plane entity.

Example 55: The method of example 54, wherein the failing of the central unit control plane entity is detected with the another central unit control plane entity via an Xn interface.

Example 56: The method of any of examples 35 to 55, wherein the failing of the central unit control plane entity is detected with an access and mobility management function.

Example 57: The method of example 56, wherein the failing of the central unit control plane entity is detected with the access and mobility management function via an NG-C interface.

Example 58: The method of any of examples 35 to 57, wherein the failing of the central unit control plane entity is detected with a service management and orchestration node.

Example 59: The method of example 58, wherein the failing of the central unit control plane entity is detected with the service management and orchestration node via an O1 interface.

Example 60: The method of any of examples 35 to 59, wherein in response to the failing of the central unit control plane entity, the near real time radio intelligent controller notifies at least one node within the associated node list that has established an interface with the near real time radio intelligent controller.

Example 61: The method of any of examples 35 to 60, wherein failure detection is performed with at least one of: at least one service response timer expiry; at least one transport network failure detection timer expiry; or an artificial intelligence or machine learning method indicating a probability of failure at a given time or time period.

Example 62: The method of example 61, further comprising: detecting falsely identified failures; wherein detecting falsely identified failures comprises at least one of: integrating reports from multiple of the at least one logical entity; or an artificial intelligence or machine learning model.

Example 63: The method of any of examples 35 to 62, wherein: the failed at least one logical entity comprises a service of the near real time radio intelligent controller; and the notification of failure comprises providing information concerning the service.

Example 64: The method of any of examples 35 to 63, wherein the associated node list is filtered prior to transmission of the notification of failure, such that a first subset of the at least one logical entity receives the notification of failure, and a second subset of the at least one logical entity does not receive the notification of the failure due to not being affected with the failure.

Example 65: An example method includes establishing an interface with at least one logical entity; and detecting a failure of the at least one logical entity and transmitting a failure notification of the at least one logical entity, or receiving a notification of failure of the at least one logical entity; wherein the notification of failure is received using an associated node list, the associated node list having been created and updated based on interface establishment between a plurality of logical entities of the at least one logical entity and/or a node configuration update procedure; wherein the at least one logical entity and the plurality of logical entities are entities of at least one access network node.

Example 66: The method of example 65, wherein the failure notification is transmitted to a central unit control plane entity.

Example 67: The method of any of examples 65 to 66, wherein the failure notification is transmitted to a standby central unit control plane entity in response to the standby central unit control plane entity existing, and in response to a failure of a central unit control plane entity.

Example 68: The method of any of examples 65 to 67, wherein the failure notification is transmitted to a near real time radio intelligent controller in response to a standby central unit control plane entity not existing, and in response to a failure of a central unit control plane entity.

Example 69: The method of any of examples 65 to 68, wherein the notification of failure is received from a central unit control plane entity.

Example 70: The method of any of examples 65 to 69, wherein the notification of failure is received from a near real time radio intelligent controller.

Example 71: The method of any of examples 65 to 70, wherein the notification of failure is received from a standby central unit control plane entity.

Example 72: The method of example 71, wherein the standby central unit control plane entity is coupled with an inactive interface connection to a near real time radio intelligent controller, where the active central unit control plane entity has a connection with a near real time radio intelligent controller.

Example 73: The method of any of examples 71 to 72, wherein the standby central unit control plane entity is coupled with an inactive interface connection to the at least one logical entity, where the at least one logical entity has a connection with an active central unit control plane entity.

Example 74: The method of example 73, wherein the at least one logical entity comprises a central unit user plane entity.

Example 75: The method of example 74, wherein the inactive interface connection comprises an E1 interface.

Example 76: The method of any of examples 73 to 75, wherein the at least one logical entity comprises a distributed unit.

Example 77: The method of example 76, wherein the inactive interface connection comprises an F1 interface.

Example 78: An example method includes receiving an associated node list from a central unit control plane entity, the associated node list having been created based on interface establishment between a plurality of logical entities of at least one logical entity and/or a node configuration update procedure; storing the associated node list, wherein the associated node list configured to be used for a notification of failure of the at least one logical entity; detecting the failure of the at least one logical entity; and performing either: transmitting a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmitting the notification of failure to a set of the at least one logical entity using the associated node list; wherein the associated node list is stored with a near real time radio intelligent controller; wherein the at least one logical entity, the plurality of logical entities, the central unit control plane entity, and the standby central unit control plane entity are entities of at least one access network node.

Example 79: The method of example 78, wherein the standby central unit is coupled to the near real time radio intelligent controller with an inactive interface connection.

Example 80: The method of any of examples 78 to 79, further comprising receiving an inactive interface setup request from the standby central unit control plane entity.

Example 81: The method of any of examples 78 to 80, further comprising transmitting a response to an inactive interface setup request from the near real time radio intelligent controller.

Example 82: The method of any of examples 78 to 81, wherein failure detection is performed with at least one of: at least one service response timer expiry; at least one transport network failure detection timer expiry; or an artificial intelligence or machine learning method indicating a probability of failure at a given time or time period.

Example 83: The method of claim 82, further comprising: detecting falsely identified failures; wherein detecting falsely identified failures comprises at least one of: integrating reports from multiple of the at least one logical entity; or an artificial intelligence or machine learning model.

Example 84: An example method includes synchronizing an associated node list between a central unit control plane entity and a standby central unit control plane entity, the associated node list configured to be used for transmission of a notification of failure; storing the associated node list; wherein the associated node list is created based on interface establishment between a plurality of logical entities of at least one logical entity; receiving a failure notification from a near real time radio intelligent controller or the at least one logical entity; and transmitting the notification of failure to the at least one logical entity using the associated node list; wherein the at least one logical entity, the plurality of logical entities, the central unit control plane entity, and the standby central unit control plane entity are entities of at least one access network node.

Example 85: The method of example 84, further comprising establishing at least one inactive interface with the at least one logical entity having an established interface with the central unit control plane entity.

Example 86: The method of example 85, further comprising receiving a setup response message in response to having completed the establishing of the at least one inactive interface with the at least one logical entity.

Example 87: The method of any of examples 84 to 86, further comprising transmitting an inactive interface setup request from the standby central unit control plane entity to the near real time radio intelligent controller.

Example 88: The method of an of examples 84 to 87, further comprising receiving a response to an inactive interface setup request from the near real time radio intelligent controller.

Example 89: The method of any of examples 84 to 88, wherein the failure notification is received from the near real time radio intelligent controller.

Example 90: The method of any of examples 84 to 89, wherein the failure notification is received from the at least one logical entity.

Example 91: An example method includes detecting a failure of a first network element with a second network element; notifying the failure of the first network element with the second network element to a central entity; notifying the failure of the first network element with the central entity to nodes within an associated node list; wherein the associated node list is created and updated based on interface establishment between a plurality of logical entities and/or a node configuration update procedure; wherein the first network element, the second network element, the central entity, and the plurality of logical entities are entities of at least one access network node.

Example 92: The method of example 91, wherein the first network element comprises a near real time radio intelligent controller, a central unit control plane entity, a central unit user plane entity, or a distributed unit.

Example 93: The method of any of examples 91 to 92, wherein the second network element that detects the failure of the first network element comprises a near real time radio intelligent controller, a central unit control plane entity, a central unit user plane entity, a distributed unit, another central unit control plane entity, an access and mobility management function, or a service management and orchestration node.

Example 94: The method of any of examples 91 to 93, wherein the associated node list comprises a near real time radio intelligent controller, a central unit control plane entity, a central unit user plane entity, a distributed unit, another central unit control plane entity, an access and mobility management function, and/or a service management and orchestration node.

Example 95: An example method includes creating a notification publish space to monitor failure, the notification publish space comprising an identifier of a central entity of an access network node being monitored for failure; wherein at least one logical entity of the access network node or of another access network node being monitored for failure subscribes to the notification publish space; detecting a failure of the central entity or of the at least one logical entity; transmitting a failure notification of the failure of the central entity or the at least one logical entity; and notifying the subscribers of the notification publish space concerning the failure of the central entity or the at least one logical entity.

Example 96: The method of example 95, wherein the failure notification of the failure comprises an identifier of the failed central entity or the identifier of the failed at least one logical entity.

Example 97: The method of any of examples 95 to 96, wherein the notifying the subscribers of the notification publish space concerning the failure of the central entity or the at least one logical entity comprises transmitting an identifier of the failed central entity or the failed at least one logical entity to the subscribers of the notification publish space.

Example 98: The method of any of examples 95 to 97, wherein the at least one logical entity subscribes to the notification publish space in response to having received an identifier of the central entity and associated publish space information.

Example 99: The method of any of examples 95 to 98, further comprising updating a publish space list with information concerning the failure of the central entity or the at least one logical entity.

Example 100: The method of any of examples 95 to 99, wherein the detecting of the failure of the central entity or of the at least one logical entity is performed with any entity of the at least one logical entity.

Example 101: An example apparatus includes at least one processor; and at least one memory including computer program code; wherein the at least one memory and the computer program code are configured to, with the at least one processor, cause the apparatus at least to: receive an indication to create a notification publish space to monitor failure, from a central entity of an access network node, the notification publish space comprising an identifier of the central entity of the access network node being monitored for failure; create the notification publish space, and sending an acknowledgement of the indication to create the notification publish space to the central entity of the access network node; receive a subscription to the notification publish space from at least one logical entity of the access network node or of another access network node; receive a failure notification of a failure of the at least one logical entity being monitored for failure; and notify the subscribers of the notification publish space concerning the failure of the at least one logical entity.

Example 102: An example apparatus includes at least one processor; and at least one memory including computer program code; wherein the at least one memory and the computer program code are configured to, with the at least one processor, cause the apparatus at least to: transmit an indication to create a notification publish space to a data storage function, the notification publish space comprising an identifier of a central entity of an access network node being monitored for failure; receive an acknowledgement of the indication to create the notification publish space from the data storage function; and transmit the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node

Example 103: An example apparatus includes at least one processor; and at least one memory including computer program code; wherein the at least one memory and the computer program code are configured to, with the at least one processor, cause the apparatus at least to: receive a identifier from a central entity of an access network node, the identifier used to identify a notification publish space of a radio access network data storage function; subscribe to the notification publish space of the radio access network data storage function using the identifier of the central entity being monitored for failure, the notification publish space used to provide or receive information concerning a failure of at least one logical entity of the access network node or of another access network node being monitored for failure; and receive a notification of failure of the at least one logical entity with the notification publish space of the radio access network data storage function, the notification of failure comprising an identifier of the failed at least one logical entity.

Example 104: An example apparatus includes at least one processor; and at least one memory including computer program code; wherein the at least one memory and the computer program code are configured to, with the at least one processor, cause the apparatus at least to: detect a failure of at least one logical entity of an access network node being monitored for failure; and transmit a notification to a radio access network data storage function of the failure of the at least one logical entity, the notification comprising an identifier of the failed at least one logical entity; wherein the notification is configured to be used with the radio access network data storage function to notify subscribers of a notification publish space concerning the failure of the at least one logical entity; wherein the notification publish space is accessible to the subscribers of the notification publish space to be notified of the failure.

Example 105: An example apparatus includes at least one processor; and at least one memory including computer program code; wherein the at least one memory and the computer program code are configured to, with the at least one processor, cause the apparatus at least to: create an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and perform at least: receive a failure notification of the at least one logical entity from a detecting logical entity that detected the failure, the failure notification including an identifier of the failed at least one logical entity, and transmitting the notification of failure of at least one logical entity using the associated node list and the identifier; detect the failure of the at least one logical entity, and transmitting the notification of failure of at least one logical entity using the associated node list and the identifier; or fail of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

Example 106: An example apparatus includes at least one processor; and at least one memory including computer program code; wherein the at least one memory and the computer program code are configured to, with the at least one processor, cause the apparatus at least to: establish an interface with at least one logical entity; and detect a failure of the at least one logical entity and transmitting a failure notification of the at least one logical entity, or receiving a notification of failure of the at least one logical entity; wherein the notification of failure is received using an associated node list, the associated node list having been created and updated based on interface establishment between a plurality of logical entities of the at least one logical entity and/or a node configuration update procedure; wherein the at least one logical entity and the plurality of logical entities are entities of at least one access network node.

Example 107: An example apparatus includes at least one processor; and at least one memory including computer program code; wherein the at least one memory and the computer program code are configured to, with the at least one processor, cause the apparatus at least to: receive an associated node list from a central unit control plane entity, the associated node list having been created based on interface establishment between a plurality of logical entities of at least one logical entity and/or a node configuration update procedure; store the associated node list, wherein the associated node list configured to be used for a notification of failure of the at least one logical entity; detect the failure of the at least one logical entity; and perform either: transmit a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmit the notification of failure to a set of the at least one logical entity using the associated node list; wherein the associated node list is stored with a near real time radio intelligent controller; wherein the at least one logical entity, the plurality of logical entities, the central unit control plane entity, and the standby central unit control plane entity are entities of at least one access network node.

Example 108: An example apparatus includes at least one processor; and at least one memory including computer program code; wherein the at least one memory and the computer program code are configured to, with the at least one processor, cause the apparatus at least to: synchronize an associated node list between a central unit control plane entity and a standby central unit control plane entity, the associated node list configured to be used for transmission of a notification of failure; store the associated node list; wherein the associated node list is created based on interface establishment between a plurality of logical entities of at least one logical entity; receive a failure notification from a near real time radio intelligent controller or the at least one logical entity; and transmit the notification of failure to the at least one logical entity using the associated node list; wherein the at least one logical entity, the plurality of logical entities, the central unit control plane entity, and the standby central unit control plane entity are entities of at least one access network node.

Example 109: An example apparatus includes at least one processor; and at least one memory including computer program code; wherein the at least one memory and the computer program code are configured to, with the at least one processor, cause the apparatus at least to: detect a failure of a first network element with a second network element; notify the failure of the first network element with the second network element to a central entity; notify the failure of the first network element with the central entity to nodes within an associated node list; wherein the associated node list is created and updated based on interface establishment between a plurality of logical entities and/or a node configuration update procedure; wherein the first network element, the second network element, the central entity, and the plurality of logical entities are entities of at least one access network node.

Example 110: An example apparatus includes at least one processor; and at least one memory including computer program code; wherein the at least one memory and the computer program code are configured to, with the at least one processor, cause the apparatus at least to: create a notification publish space to monitor failure, the notification publish space comprising an identifier of a central entity of an access network node being monitored for failure; wherein at least one logical entity of the access network node or of another access network node being monitored for failure subscribes to the notification publish space; detect a failure of the central entity or of the at least one logical entity; transmit a failure notification of the failure of the central entity or the at least one logical entity; and notify the subscribers of the notification publish space concerning the failure of the central entity or the at least one logical entity.

Example 111: An example apparatus includes means for receiving an indication to create a notification publish space to monitor failure, from a central entity of an access network node, the notification publish space comprising an identifier of the central entity of the access network node being monitored for failure; means for creating the notification publish space, and sending an acknowledgement of the indication to create the notification publish space to the central entity of the access network node; means for receiving a subscription to the notification publish space from at least one logical entity of the access network node or of another access network node; means for receiving a failure notification of a failure of the at least one logical entity being monitored for failure; and means for notifying the subscribers of the notification publish space concerning the failure of the at least one logical entity.

Example 112: An example apparatus includes means for transmitting an indication to create a notification publish space to a data storage function, the notification publish space comprising an identifier of a central entity of an access network node being monitored for failure; means for receiving an acknowledgement of the indication to create the notification publish space from the data storage function; and means for transmitting the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node.

Example 113: An example apparatus includes means for receiving a identifier from a central entity of an access network node, the identifier used to identify a notification publish space of a radio access network data storage function; means for subscribing to the notification publish space of the radio access network data storage function using the identifier of the central entity being monitored for failure, the notification publish space used to provide or receive information concerning a failure of at least one logical entity of the access network node or of another access network node being monitored for failure; and means for receiving a notification of failure of the at least one logical entity with the notification publish space of the radio access network data storage function, the notification of failure comprising an identifier of the failed at least one logical entity.

Example 114: An example apparatus includes means for detecting a failure of at least one logical entity of an access network node being monitored for failure; and means for transmitting a notification to a radio access network data storage function of the failure of the at least one logical entity, the notification comprising an identifier of the failed at least one logical entity; wherein the notification is configured to be used with the radio access network data storage function to notify subscribers of a notification publish space concerning the failure of the at least one logical entity; wherein the notification publish space is accessible to the subscribers of the notification publish space to be notified of the failure.

Example 115: An example apparatus includes means for creating an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and means for performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

Example 116: An example apparatus includes means for creating an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and means for performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

Example 117: An example apparatus includes means for receiving an associated node list from a central unit control plane entity, the associated node list having been created based on interface establishment between a plurality of logical entities of at least one logical entity and/or a node configuration update procedure; means for storing the associated node list, wherein the associated node list configured to be used for a notification of failure of the at least one logical entity; means for detecting the failure of the at least one logical entity; and means for performing either: transmitting a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmitting the notification of failure to a set of the at least one logical entity using the associated node list; wherein the associated node list is stored with a near real time radio intelligent controller; wherein the at least one logical entity, the plurality of logical entities, the central unit control plane entity, and the standby central unit control plane entity are entities of at least one access network node.

Example 118: An example apparatus includes means for synchronizing an associated node list between a central unit control plane entity and a standby central unit control plane entity, the associated node list configured to be used for transmission of a notification of failure; means for storing the associated node list; wherein the associated node list is created based on interface establishment between a plurality of logical entities of at least one logical entity; means for receiving a failure notification from a near real time radio intelligent controller or the at least one logical entity; and means for transmitting the notification of failure to the at least one logical entity using the associated node list; wherein the at least one logical entity, the plurality of logical entities, the central unit control plane entity, and the standby central unit control plane entity are entities of at least one access network node.

Example 119: An example apparatus includes means for detecting a failure of a first network element with a second network element; means for notifying the failure of the first network element with the second network element to a central entity; means for notifying the failure of the first network element with the central entity to nodes within an associated node list; wherein the associated node list is created and updated based on interface establishment between a plurality of logical entities and/or a node configuration update procedure; wherein the first network element, the second network element, the central entity, and the plurality of logical entities are entities of at least one access network node.

Example 120: An example apparatus includes means for creating a notification publish space to monitor failure, the notification publish space comprising an identifier of a central entity of an access network node being monitored for failure; wherein at least one logical entity of the access network node or of another access network node being monitored for failure subscribes to the notification publish space; means for detecting a failure of the central entity or of the at least one logical entity; means for transmitting a failure notification of the failure of the central entity or the at least one logical entity; and means for notifying the subscribers of the notification publish space concerning the failure of the central entity or the at least one logical entity.

Example 121: An example non-transitory program storage device readable by a machine, tangibly embodying a program of instructions executable with the machine for performing operations is provided/described, the operations comprising: receiving an indication to create a notification publish space to monitor failure, from a central entity of an access network node, the notification publish space comprising an identifier of the central entity of the access network node being monitored for failure; creating the notification publish space, and sending an acknowledgement of the indication to create the notification publish space to the central entity of the access network node; receiving a subscription to the notification publish space from at least one logical entity of the access network node or of another access network node; receiving a failure notification of a failure of the at least one logical entity being monitored for failure; and notifying the subscribers of the notification publish space concerning the failure of the at least one logical entity.

Example 122: An example non-transitory program storage device readable by a machine, tangibly embodying a program of instructions executable with the machine for performing operations is provided/described, the operations comprising: transmitting an indication to create a notification publish space to a data storage function, the notification publish space comprising an identifier of a central entity of an access network node being monitored for failure; receiving an acknowledgement of the indication to create the notification publish space from the data storage function; and transmitting the identifier of the central entity and associated publish space information to at least one logical entity of the access network node or of another access network node being monitored for failure; wherein the identifier of the central entity is configured to be used with the at least one logical entity to subscribe to the notification publish space to receive information concerning a failure of the at least one logical entity of the access network node or of the another access network node.

Example 123: An example non-transitory program storage device readable by a machine, tangibly embodying a program of instructions executable with the machine for performing operations is provided/described, the operations comprising: receiving a identifier from a central entity of an access network node, the identifier used to identify a notification publish space of a radio access network data storage function; subscribing to the notification publish space of the radio access network data storage function using the identifier of the central entity being monitored for failure, the notification publish space used to provide or receive information concerning a failure of at least one logical entity of the access network node or of another access network node being monitored for failure; and receiving a notification of failure of the at least one logical entity with the notification publish space of the radio access network data storage function, the notification of failure comprising an identifier of the failed at least one logical entity.

Example 124: An example non-transitory program storage device readable by a machine, tangibly embodying a program of instructions executable with the machine for performing operations is provided/described, the operations comprising: detecting a failure of at least one logical entity of an access network node being monitored for failure; and transmitting a notification to a radio access network data storage function of the failure of the at least one logical entity, the notification comprising an identifier of the failed at least one logical entity; wherein the notification is configured to be used with the radio access network data storage function to notify subscribers of a notification publish space concerning the failure of the at least one logical entity; wherein the notification publish space is accessible to the subscribers of the notification publish space to be notified of the failure.

Example 125: An example non-transitory program storage device readable by a machine, tangibly embodying a program of instructions executable with the machine for performing operations is provided/described, the operations comprising: creating an associated node list, the associated node list configured to be used for a notification of failure of at least one logical entity, wherein the notification of failure is performed using at last one point to point interface in a radio access network; wherein the associated node list is created and updated based on interface establishment between a plurality of logical entities of the at least one logical entity and/or a node configuration update procedure; and performing at least: receiving a failure notification of the at least one logical entity from a detecting logical entity that detected the failure, the failure notification including an identifier of the failed at least one logical entity, and transmitting the notification of failure of at least one logical entity using the associated node list and the identifier; detecting the failure of the at least one logical entity, and transmitting the notification of failure of at least one logical entity using the associated node list and the identifier; or failing of a central unit control plane entity, wherein: a failure notification of the failing central unit control plane entity is transmitted to a standby entity from a near real time radio intelligent controller having an inactive interface established with the standby entity, or from the at least one logical entity having an inactive interface established with the standby entity, where the stand by entity transmits the notification of failure using the associated node list and the identifier to a non-failing at least one logical entity, after the at least one logical entity has detected the failure; or the notification of failure is transmitted from the near real time radio intelligent controller to the non-failing at least one logical entity with use of the associated node list, after the near real time radio intelligent controller has detected the failure or after the at least one logical entity has detected the failure and has notified the near real time radio intelligent controller; wherein the at least one logical entity, the plurality of logical entities, the central unit control plane entity, the standby entity, and the non-failing at least one logical entity are entities of at least one access network node.

Example 126: An example non-transitory program storage device readable by a machine, tangibly embodying a program of instructions executable with the machine for performing operations is provided/described, the operations comprising: establishing an interface with at least one logical entity; and detecting a failure of the at least one logical entity and transmitting a failure notification of the at least one logical entity, or receiving a notification of failure of the at least one logical entity; wherein the notification of failure is received using an associated node list, the associated node list having been created and updated based on interface establishment between a plurality of logical entities of the at least one logical entity and/or a node configuration update procedure; wherein the at least one logical entity and the plurality of logical entities are entities of at least one access network node.

Example 127: An example non-transitory program storage device readable by a machine, tangibly embodying a program of instructions executable with the machine for performing operations is provided/described, the operations comprising: receiving an associated node list from a central unit control plane entity, the associated node list having been created based on interface establishment between a plurality of logical entities of at least one logical entity and/or a node configuration update procedure; storing the associated node list, wherein the associated node list configured to be used for a notification of failure of the at least one logical entity; detecting the failure of the at least one logical entity; and performing either: transmitting a failure notification to a standby central unit control plane entity, wherein the standby central unit control plane entity transmits the notification of failure using the associated node list, and transmitting the failure notification to the central unit control plane entity in response to the failure of the at least one logical entity being attributed to a distributed unit or a central unit user plane entity; or transmitting the notification of failure to a set of the at least one logical entity using the associated node list; wherein the associated node list is stored with a near real time radio intelligent controller; wherein the at least one logical entity, the plurality of logical entities, the central unit control plane entity, and the standby central unit control plane entity are entities of at least one access network node.

Example 128: An example non-transitory program storage device readable by a machine, tangibly embodying a program of instructions executable with the machine for performing operations is provided/described, the operations comprising: synchronizing an associated node list between a central unit control plane entity and a standby central unit control plane entity, the associated node list configured to be used for transmission of a notification of failure; storing the associated node list; wherein the associated node list is created based on interface establishment between a plurality of logical entities of at least one logical entity; receiving a failure notification from a near real time radio intelligent controller or the at least one logical entity; and transmitting the notification of failure to the at least one logical entity using the associated node list; wherein the at least one logical entity, the plurality of logical entities, the central unit control plane entity, and the standby central unit control plane entity are entities of at least one access network node.

Example 129: An example non-transitory program storage device readable by a machine, tangibly embodying a program of instructions executable with the machine for performing operations is provided/described, the operations comprising: detecting a failure of a first network element with a second network element; notifying the failure of the first network element with the second network element to a central entity; notifying the failure of the first network element with the central entity to nodes within an associated node list; wherein the associated node list is created and updated based on interface establishment between a plurality of logical entities and/or a node configuration update procedure; wherein the first network element, the second network element, the central entity, and the plurality of logical entities are entities of at least one access network node.

Example 130: An example non-transitory program storage device readable by a machine, tangibly embodying a program of instructions executable with the machine for performing operations is provided/described, the operations comprising: creating a notification publish space to monitor failure, the notification publish space comprising an identifier of a central entity of an access network node being monitored for failure; wherein at least one logical entity of the access network node or of another access network node being monitored for failure subscribes to the notification publish space; detecting a failure of the central entity or of the at least one logical entity; transmitting a failure notification of the failure of the central entity or the at least one logical entity; and notifying the subscribers of the notification publish space concerning the failure of the central entity or the at least one logical entity.

Example 131: An apparatus comprising circuitry configured to perform the method of any of examples 1 to 15.

Example 132: An apparatus comprising circuitry configured to perform the method of any of examples 16 to 23.

Example 133: An apparatus comprising circuitry configured to perform the method of any of examples 24 to 29.

Example 134: An apparatus comprising circuitry configured to perform the method of any of examples 30 to 34.

Example 135: An apparatus comprising circuitry configured to perform the method of any of examples 35 to 64.

Example 136: An apparatus comprising circuitry configured to perform the method of any of examples 65 to 77.

Example 137: An apparatus comprising circuitry configured to perform the method of any of examples 78 to 83.

Example 138: An apparatus comprising circuitry configured to perform the method of any of examples 84 to 90.

Example 139: An apparatus comprising circuitry configured to perform the method of any of examples 91 to 94.

Example 140: An apparatus comprising circuitry configured to perform the method of any of examples 95 to 100.

Example 141: An apparatus comprising means for performing the method of any of examples 1 to 15.

Example 142: An apparatus comprising means for performing the method of any of examples 16 to 23.

Example 143: An apparatus comprising means for performing the method of any of examples 24 to 29.

Example 144: An apparatus comprising means for performing the method of any of examples 30 to 34.

Example 145: An apparatus comprising means for performing the method of any of examples 35 to 64.

Example 146: An apparatus comprising means for performing the method of any of examples 65 to 77.

Example 147: An apparatus comprising means for performing the method of any of examples 78 to 83.

Example 148: An apparatus comprising means for performing the method of any of examples 84 to 90.

Example 149: An apparatus comprising means for performing the method of any of examples 91 to 94.

Example 150: An apparatus comprising means for performing the method of any of examples 95 to 100.

Example 151: An apparatus comprising at least one processor; and at least one memory including computer program code; wherein the at least one memory and the computer program code are configured to, with the at least one processor, cause the apparatus at least to perform the method of any of examples 1 to 15.

Example 152: An apparatus comprising at least one processor; and at least one memory including computer program code; wherein the at least one memory and the computer program code are configured to, with the at least one processor, cause the apparatus at least to perform the method of any of examples 16 to 23.

Example 153: An apparatus comprising at least one processor; and at least one memory including computer program code; wherein the at least one memory and the computer program code are configured to, with the at least one processor, cause the apparatus at least to perform the method of any of examples 24 to 29.

Example 154: An apparatus comprising at least one processor; and at least one memory including computer program code; wherein the at least one memory and the computer program code are configured to, with the at least one processor, cause the apparatus at least to perform the method of any of examples 30 to 34.

Example 155: An apparatus comprising at least one processor; and at least one memory including computer program code; wherein the at least one memory and the computer program code are configured to, with the at least one processor, cause the apparatus at least to perform the method of any of examples 35 to 64.

Example 156: An apparatus comprising at least one processor; and at least one memory including computer program code; wherein the at least one memory and the computer program code are configured to, with the at least one processor, cause the apparatus at least to perform the method of any of examples 65 to 77.

Example 157: An apparatus comprising at least one processor; and at least one memory including computer program code; wherein the at least one memory and the computer program code are configured to, with the at least one processor, cause the apparatus at least to perform the method of any of examples 78 to 83.

Example 158: An apparatus comprising at least one processor; and at least one memory including computer program code; wherein the at least one memory and the computer program code are configured to, with the at least one processor, cause the apparatus at least to perform the method of any of examples 84 to 90.

Example 159: An apparatus comprising at least one processor; and at least one memory including computer program code; wherein the at least one memory and the computer program code are configured to, with the at least one processor, cause the apparatus at least to perform the method of any of examples 91 to 94.

Example 160: An apparatus comprising at least one processor; and at least one memory including computer program code; wherein the at least one memory and the computer program code are configured to, with the at least one processor, cause the apparatus at least to perform the method of any of examples 95 to 100.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment.

Accordingly, this description is intended to embrace all such alternatives, modifications and variances which fall within the scope of the appended claims.

When a reference number as used herein is of the form y-x, this means that the referred to item may be an instantiation of (or type of) reference number y. For example, E2 node 434-2 and E2 node 434-3 in FIG. 4 are instantiations of (e.g. a first and second instantiation) or types of or alternative types of the E2 node 434 shown in FIG. 4, and as an example, module 121-1 and 121-2 of the UE 110 of FIG. 1 may be instantiations of a common module while in other examples module 121-1 and 121-2 are not instantiations of a common module.

In the figures, lines represent couplings and arrows represent directional couplings or direction of data flow in the case of use for an apparatus, and lines represent couplings and arrows represent transitions or direction of data flow in the case of use for a method or signaling diagram.

The following acronyms and abbreviations that may be found in the specification and/or the drawing figures are defined as follows (different acronyms may be appended using a dash/hyphen e.g. “-” or with parentheses e.g. “( )”):
3GPP third generation partnership project
4G fourth generation
5G fifth generation
5GC 5G core network
5GS 5G system
6G sixth generation
A1 interface between ONAP and RIC, or reference point between non-RT RIC and near-RT RIC in oRAN
AI artificial intelligence
AF application function
AMF access and mobility management function
AN access network
API application programming interface
ASIC application-specific integrated circuit
AUSF authentication server function
C control plane
CN core network
CP control plane
CPC computer program code
C-plane control plane
CPU central processing unit
CU central unit or centralized unit
CU-CP central unit control plane
CU-UP central unit user plane
DAF data analytics function
DN data network
DSF data storage function
DSP digital signal processor
DU distributed unit
E1 interface connecting two disaggregated O-CU user and control planes
E2 reference point (in ORAN) between the RIC near-RT and the RAN or E2 node
E2AP E2 application protocol
E2GAP E2 general aspects and principles
EDGE enhanced data rates for GSM evolution
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 interface between CU and DU, e.g. F1-C or F1-U
FPGA field-programmable gate array
gNB base station for 5G/NR, i.e., a node providing NR user plane and control plane protocol terminations towards the UE, and connected via the NG interface to the 5GC
GSM global system for mobile communications
HTTP(S) hypertext transfer protocol secure
ID identifier
IEEE Institute of Electrical and Electronics Engineers
I/F interface
I/O input/output
Itf interface
KPI key performance indicator
LMF location management function
LTE long term evolution (4G)
MAC medium access control
MEC mobile edge computing
ML machine learning
MME mobility management entity
MnS management service
N1 interface from user equipment (UE) to the AMF
N2 control plane signaling between PAN and 5G core
N3 interface conveying user data from the PAN to the user plane function
N4 bridge between the control plane and the user plane
N6 interface providing connectivity between the user plane function (UPF) and any other external (or internal) networks or service platforms
N9 interface between different UPFs
Naf service based interface for an AF
Namf service based interface for an AMF
Nausf service based interface for an AUSF
NCE network control element
NE network element
NEF network exposure function
NF network function
ng or NG new generation
NG-C NG control plane interface
ng-eNB new generation eNB
NG-RAN new generation radio access network
Nnef service based interface for an NEF
Nnrf service based interface for an NRF
Nnssf service based interface for an NSSF
Npcf service based interface for a PCF
NR new radio (5G)
NRF network repository function
Nsmf service based interface for an SMF
NSSF network slice selection function
N/W network
O- O-RAN
O1 interface to provide operation and management of CU, DU, RU, and near-RT RIC to the SMO
O2 interface between SMO and PAN applications and between the SMO and O-Cloud
OAM operations, administration and maintenance
O-Cloud cloud computing platform made up of the physical infrastructure nodes using the O-RAN architecture
O-CU O-RAN central unit
O-CU-CP O-RAN central unit—control plane
O-CU-UP O-RAN central unit—user plane
O-DU O-RAN distributed unit
ONAP open networking automation platform
oRAN or O-RAN open radio access network
P2P point-to-point
PCF policy control function
PDCP packet data convergence protocol
PHY physical layer
PLMN public land mobile network
PM preventive maintenance
Pt point
rApp applications run on the non-RT RIC developed by third party specialist software providers
RAN radio access network
Rel. release
RIC radio/RAN intelligent controller
RICARCH RIC architecture
RLC radio link control
RLF radio link failure
RRC radio resource control (protocol)
RRH remote radio head
RT or -RT real-time
RU radio unit
RWS RAN 5G workshop
Rx receive or receiver or reception
SBA service-based architecture
SBI service-based interface
SBMA service based management architecture
SB-RAN service based RAN
SCP service communication proxy
SCTP stream control transmission protocol
SDAP service data adaptation protocol
SGW serving gateway
SID study item description
SMF session management function
SMO service management and orchestration
SON self-organizing/optimizing network
TS technical specification
Tx transmit or transmitter or transmission
U user plane
UDM unified data management
UE user equipment (e.g., a wireless, typically mobile device)
UP user plane
UPF user plane function
U-plane user plane
UTRA universal terrestrial radio access
WG working group
Wi-Fi family of wireless network protocols, based on the IEEE 802.11 family of standards
WLAN wireless local area network
X2 interface between two radio nodes (e.g. two eNBs)
xApp applications run on the near-RT RIC developed by third party specialist software providers
Xn interface between two NG-RAN nodes

1. A method comprising:
receiving an indication to create a notification publish space to monitor failure, from a central entity of an access network node, the notification publish space comprising an identifier of the central entity of the access network node being monitored for failure;
creating the notification publish space, and sending an acknowledgement of the indication to create the notification publish space to the central entity of the access network node;
receiving a subscription to the notification publish space from at least one logical entity of the access network node or of another access network node;
receiving a failure notification of a failure of the at least one logical entity being monitored for failure; and
notifying the subscribers of the notification publish space concerning the failure of the at least one logical entity.

2. The method of claim 1, wherein the failure notification of the failure comprises an identifier of the failed at least one logical entity.

3. The method of claim 1, wherein the notifying the subscribers of the notification publish space concerning the failure of the at least one logical entity comprises transmitting an identifier of the failed at least one logical entity to the subscribers of the notification publish space.

4. The method of claim 1, further comprising filtering the at least one logical entity prior to notifying the notification publish space concerning the failure of the at least one logical entity, such that a first subset of the at least one logical entity receives the notification of the failure, and a second subset of the at least one logical entity does not receive the notification of the failure due to not being affected with the failure.

5. A method comprising:
transmitting an indication to create a notification publish space to a data storage function, the notification publish space comprising an identifier of a central entity of an access network node being monitored for failure;
receiving an acknowledgement of the indication to create the notification publish space from the data storage function; and
transmitting the identifier of the central entity and associated publish space information to at least one logical entity of the access network node or of another access network node being monitored for failure;
wherein the identifier of the central entity is configured to be used with the at least one logical entity to subscribe to the notification publish space to receive information concerning a failure of the at least one logical entity of the access network node or of the another access network node.

6. The method of claim 5, wherein the central entity comprises either a central unit control plane entity or a near real time radio intelligent controller.

7. The method of claim 5, further comprising:
detecting the failure of the at least one logical entity of the access network node or of the another access network node; and
notifying a data storage function of the failure, the notifying comprising including an identifier of the failed at least one logical entity.

8. The method of claim 7, wherein detecting the failure is performed with at least one of:
at least one service response timer expiry;
at least one transport network failure detection timer expiry; or
an artificial intelligence or machine learning method indicating a probability of failure at a given time or time period.

9. The method of claim 7, further comprising filtering the at least one logical entity prior to notifying the data storage function of the failure of the at least one logical entity, such that a first subset of the at least one logical entity receives a failure notification, and a second subset of the at least one logical entity does not receive the failure notification.

10. The method of claim 5, further comprising subscribing to the notification publish space.

11. The method of claim 5, further comprising detecting falsely identified failures.

12. The method of claim 11, wherein detecting falsely identified failures comprises at least one of:
integrating reports from multiple of the at least one logical entity; or
an artificial intelligence or machine learning model.

13. A method comprising:
receiving an identifier from a central entity of an access network node, the identifier used to identify a notification publish space of a radio access network data storage function;
subscribing to the notification publish space of the radio access network data storage function using the identifier of the central entity being monitored for failure, the notification publish space used to provide or receive information concerning a failure of at least one logical entity of the access network node or of another access network node being monitored for failure; and
receiving a notification of failure of the at least one logical entity with the notification publish space of the radio access network data storage function, the notification of failure comprising an identifier of the failed at least one logical entity.

14. The method of claim 13, further comprising:
detecting the failure of the at least one logical entity; and
notifying a data storage function of the failure, the notifying comprising including an identifier of the failed at least one logical entity.

15. The method of claim 14, wherein detecting the failure is performed with at least one of:
at least one service response timer expiry;
at least one transport network failure detection timer expiry; or
an artificial intelligence or machine learning method indicating a probability of failure at a given time or time period.

16. A method comprising:
detecting a failure of at least one logical entity of an access network node being monitored for failure; and
transmitting a notification to a radio access network data storage function of the failure of the at least one logical entity, the notification comprising an identifier of the failed at least one logical entity;
wherein the notification is configured to be used with the radio access network data storage function to notify subscribers of a notification publish space concerning the failure of the at least one logical entity;
wherein the notification publish space is accessible to the subscribers of the notification publish space to be notified of the failure.

17. The method of claim 16, wherein detecting the failure comprises utilizing previously collected failure statistics and other information stored within a radio access network data storage function.

18. The method of claim 16, wherein detecting the failure is performed with at least one of:
at least one service response timer expiry;
at least one transport network failure detection timer expiry; or
an artificial intelligence or machine learning method indicating a probability of failure at a given time or time period.

19-30. (canceled)
